(19) United States
(12) Patent Application Publication
(10) Pub. No.: US 2018/0286258 A1
(43) Pub. Date: Oct. 4, 2018

(54) Virtual Radar Apparatus and Method

(71) Applicant: Airprox USA, Inc., Dover, DE (US)

(72) Inventor: Mathieu A. Derbanne, Chatillon (FR)

(73) Assignee: Airprox USA, Inc., Dover, DE (US)

(21) Appl. No.: 15/924,571

(22) Filed: Mar. 19, 2018

Related U.S. Application Data
(60) Provisional application No. 62/479,435, filed on Mar. 31, 2017.

(51) Int. Cl. G08G 9/02; G01S 19/15; G01S 19/37

(52) U.S. Cl. CPC G08G 9/02; B64D 45/00; G01S 19/37; G01S 19/15

(57) ABSTRACT

A virtual radar system. In one embodiment, the system includes a vehicle-based mobile device subsystem, said vehicle-based mobile device subsystem located in a vehicle; a control station subsystem, and a cloud-based data subsystem comprising a cloud-based database for holding data regarding a plurality of locations of a plurality of vehicles and a plurality of cloud transaction processors in communication with the cloud-based database. In another embodiment, said cloud transaction processors calculate the positions of the plurality of vehicles, their trajectories, and the probability of a collision between vehicles and issue a warning to the vehicles in response thereto.

### RELATED APPLICATIONS

This application claims priority to U.S. Provisional Patent Application No. 62/479,435 filed on Mar. 31, 2017, the contents of which is incorporated herein by reference in its entirety.

### FIELD OF THE INVENTION

The invention relates generally to a system and method for locating objects in the vicinity of a vehicle without the need for on-board proximity detection systems and, more specifically, for locating the position of objects in the vicinity of a vehicle using a server-based database.

### BACKGROUND OF THE INVENTION

The invention provides any vehicle, or for that matter any object, with an elegant yet simple solution to help enhance safety by constructing a virtual radar system to be used by both a vehicle operator and by a traffic control operator or other operators or controllers. The vehicles may be aircraft, land craft or watercraft and the traffic control operators may be air traffic control, land traffic control, or harbor control operators. By leveraging the computing power of the internet cloud in conjunction with widely available technologies such as the internet, cellular networks and industry-grade encryption, substantially any vehicle becomes a connected object, providing added safety and value-added services through an easily expandable software infrastructure.

Aircraft, for years, have been monitored and controlled in airspace by civilian and military air traffic control operators. This monitoring and control is generally maintained through the use of aircraft transponders, to identify aircraft, and RADAR to locate the aircraft in the surveilled three-dimensional airspace. This strict control of airspace, especially congested airspace in the vicinity of airports, has reduced the risk of collision even as the number of aircraft seeking to land or take off from the various airports has significantly increased.

However, once on the ground, the crowded conditions caused by the various aircraft, landing, taking off, taxiing, or parked, in conjunction with the numerous other types of vehicles, such as fuel trucks, cars, cargo carriers, and tugs in conjunction with stationary objects such as buildings, paved and unpaved ways, and other structures, such as radio masts, portable shelters and construction materials, make the airport or seaport an equally dangerous place for both the aircraft, or seacraft, respectively, and the other vehicles, persons, and objects moving in close proximity to one another.

Surface Movement RADAR (SMR) systems supplement visual determinations by traffic controllers and address some of these collision avoidance issues for aircraft on the ground. However, these systems are expensive, are somewhat hampered by objects in the way of the scanning radar beam, and may not have the resolution to detect something as small as a tug with enough resolution to detect collision trajectories.

The present invention addresses these needs.

### SUMMARY OF THE INVENTION

In one aspect, the invention relates to a virtual radar system. In one embodiment, the system includes a vehicle-based subsystem, the vehicle-based subsystem located in a vehicle. In another embodiment, the vehicle-based subsystem includes a GNSS receiver to generate a position location for the vehicle; a vehicle subsystem processor in communication with the GNSS receiver; a vehicle-based human interface subsystem including a display and a data input unit; and a vehicle-based network modem in communication with the vehicle subsystem processor. In still another embodiment, the system includes a control station subsystem, the control station subsystem including a control station subsystem processor; a control station subsystem-based human interface subsystem including a control system-based display and a control system-based data input unit, the control station subsystem-based human interface subsystem in communication with the control station subsystem processor; and a control station subsystem network modem in communication with the control station subsystem processor.

In one embodiment, the system includes a cloud-based data subsystem that includes multiple databases with various functions. In another embodiment, the cloud-based data subsystem includes a cloud-based non-persistent or temporary database for holding data regarding a plurality of locations of a plurality of vehicles; a secure persistent virtual black box database; a database for exclusive use by the artificial intelligence (AI) portion of the subsystem; a plurality of cloud transaction processors in communication with the cloud-based databases; and a cloud-based network modem in communication with the plurality of transaction processors. In another embodiment, the cloud transaction processors calculate the positions of the plurality of vehicles, their trajectories, and the probability of there being a collision between vehicles, and issue a warning to the vehicles in response thereto.

In one embodiment, the virtual radar system includes a vehicle-based mobile device subsystem. The vehicle-based mobile device subsystem, located in a vehicle, includes: a GNSS receiver to generate a position location for the vehicle; a vehicle subsystem processor in communication with a the GNSS receiver; a vehicle-based human interface subsystem including a display and a data input unit; a vehicle-based network modem in communication with the vehicle-based mobile device subsystem processor; and a cloud-based data subsystem including: a cloud-based database for holding data comprising a plurality of locations of a plurality of vehicles; a plurality of cloud transaction processors in communication with the cloud-based database; and a cloud-based network modem in communication with the plurality of transaction processors, wherein the cloud transaction processors calculate the positions of the plurality of vehicles, their trajectories, and the probability of there being a collision between vehicles and issues a warning to the vehicles in response thereto.

In another embodiment, the virtual radar system further includes a control station subsystem, including a control station subsystem processor; a control station subsystem-based human interface subsystem comprising a control system-based display and a control system-based data input unit, the control station subsystem-based human interface subsystem in communication with said control station subsystem processor; a control station subsystem network modem in communication with the control station subsystem processor. In yet another embodiment, both the vehicle-based subsystem and the control station subsystem further each include a cryptographic engine in communication between their respective network modem and their respective processor. In still another embodiment, the cloud transaction processors include a position processing engine; an AI engine; a black box storage database; a transient database in communication with the position processing engine and the AI engine; and an AI database in communication with the position processing engine and the AI engine. In still yet another embodiment, the AI engine includes a path prediction engine; a collision prediction engine; and a machine learning engine. In one embodiment, the collision prediction engine issues a collision alert in response to predicted path data from the path prediction engine.

In another aspect, the invention relates to a virtual radar system vehicle-based mobile device subsystem. In one embodiment, the vehicle-based mobile device subsystem includes a CPU; a modem comprising a first GNSS receiver in communication with the CPU; and an audio codec in communication with the CPU, wherein the first GNSS receiver provides position data to the CPU, and wherein the CPU transmits the GNSS position data to a cloud transaction server for collision prediction. In another embodiment, the vehicle-based mobile device subsystem further includes a second GNSS receiver in communication with the CPU, the second GNSS receiver providing position data to the CPU. In yet another embodiment, the CPU generates an error warning if the position data indicated by the first and second GNSS receivers differ by more than a predetermined amount. In still another embodiment, the virtual radar system vehicle-based subsystem includes a Bluetooth modem in communication with the CPU. In still yet another embodiment, the virtual radar system vehicle-based subsystem includes a plurality of vehicle system sensors and external sensors in communication with the CPU.

In another aspect, the invention relates to a method of operating a virtual radar system including a server, a plurality of vehicle-based mobile device subsystems, and a cloud based data subsystem comprising a plurality of databases. In one embodiment, the method includes the steps of registering each of the vehicle-based mobile device subsystems with the cloud based data subsystem; creating a record for each of the plurality of the vehicle-based mobile device subsystems in one of the plurality of databases in the cloud based data subsystem; receiving, by the server, a respective position message from each of the plurality of vehicle-based mobile device subsystems and storing it in a position database in the cloud-based data subsystem; receiving, by the server, a subsequent position message from each of the plurality of the vehicle-based mobile device subsystems and storing it the position database in the cloud-based data subsystem; calculating, by the server, a trajectory for each of the plurality of the vehicle-based mobile device subsystems; calculating, by the server, the distance between each of the plurality of vehicle-based mobile device subsystems based on their respective trajectories; and issuing by the server, a collision warning to each of the vehicle-based mobile device subsystems whose trajectories will pass within a predetermined volume of space of each other at a specific point in time. In another embodiment, the method of operating a virtual radar system includes a control station subsystem and the server also issues the collision warning to the control station subsystem. In still another embodiment, the predetermined volume of space is determined by an AI engine in response to the positions of each of the vehicle-based mobile device subsystems. In yet another embodiment, the method of operating a virtual radar system further includes the step of deregistering a vehicle-based mobile device subsystem that is no longer active. In still yet another embodiment, the method of operating a virtual radar system further includes the step of closing the record of the inactive vehicle-based mobile device subsystem. In another embodiment, the method of operating a virtual radar system further includes the step of maintaining the record of the inactive vehicle-based mobile device subsystem in a black box database.

### BRIEF DESCRIPTION OF THE DRAWINGS

The figures are not necessarily to scale, emphasis instead generally being placed upon illustrative principles. The figures are to be considered illustrative in all aspects and are not intended to limit the invention, the scope of which is defined only by the claims. The present description will be best understood by reference to the specification and the drawings in which:

FIG. 1 is a highly schematic representation of an overview of an embodiment of the system;

FIG. 2 is a data diagram depicting an embodiment of data flow to the cloud servers from a vehicle equipped with the invention;

FIG. 3 is a data diagram depicting an embodiment of the flow to the cloud servers of optional data from a vehicle equipped with the invention;

FIG. 4 is a data diagram depicting an embodiment of data flow from the cloud to a vehicle equipped with the invention;

FIG. 5 is a data diagram depicting an embodiment of data flow between the cloud and a ground station equipped with the invention;

FIG. 6 is a data diagram depicting an embodiment of data flow from the cloud to a ground station equipped with the invention;

FIG. 7 is a data diagram depicting an embodiment of the flow of data to the cloud servers from a ground station equipped with the invention;

FIG. 8 is a data diagram depicting an embodiment of the flow of data within the cloud;

FIG. 9 is a detailed data diagram depicting an embodiment of the flow of data within the data processors of FIG. 8;

FIG. 10A is a detailed data diagram depicting an embodiment of the flow of data within the artificial intelligence engine of the data processors of FIG. 9;

FIG. 10B is a highly schematic diagram of a multilevel neural network embodiment of a learning engine of FIG. 10A;

FIG. 11 is a detailed data diagram depicting an embodiment of the flow of data within the black box database storage of FIG. 8;

FIG. 12 is a detailed data diagram depicting an embodiment of the flow of data within the messaging engine of FIG. 8;

FIG. 13 is an embodiment of a data and hardware diagram of a vehicle-based unit used in a manned vehicle;

FIG. 14 is an embodiment of a data and hardware diagram of a vehicle-based unit used in an unmanned vehicle;

FIG. 15 is a diagram of an embodiment of a software security system as used by the invention;

FIGS. 16A and 16B denote an embodiment of a flow diagram for the message reception and analysis process of the system;

FIG. 16C is an embodiment of a flow diagram of the registration step of FIG. 16A;

FIGS. 17A and 17B denote an embodiment of a flow diagram for the collision and proximity warning process of the system;

FIG. 18 is an embodiment of a data and hardware diagram of an always-on vehicle-installed device; and

FIGS. 19A, 19B, and 19C represent a circuit layout view of one embodiment of the always-on device of FIG. 18.

### DESCRIPTION OF A PREFERRED EMBODIMENT

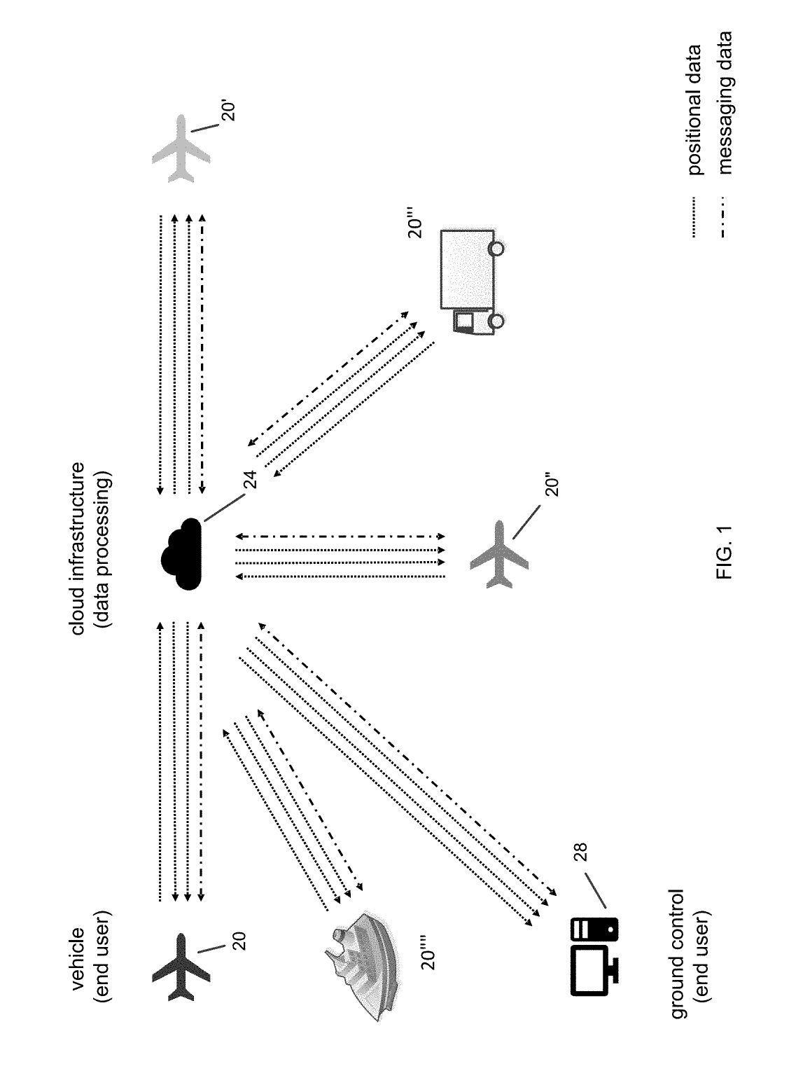

Referring to FIG. 1, a general mode of operation of the system of the invention is shown. Each mobile user vehicle 20, 20′, 20″, 20′″, 20″″ (generally 20), which may include aircraft, ground vehicles, water vehicles, other movable objects and even individuals uses a vehicle-based mobile unit (described below) that sends position updates to the system's servers 24 at a given update frequency which depends on the vehicle type and its potential speed. For simplicity, the application refers to vehicle-based mobile units or vehicle-based device interchangeably and without regard to what object actually includes the device. For example, an aircraft in the air may have its position updated 4 times per second, while an aircraft on the ground may update once every second and a boat's position may be updated 10 times per minute. In one embodiment, the servers are in the internet cloud but in other embodiments, the servers may be located locally. The servers 24 periodically send the positions of each nearby user to each vehicle-based mobile device 20, 20′, 20″, 20′″, 20″″. Users' positions are also sent to ground station operators 28 who are also equipped with a computer (including, but not limited to, a smart phone, a desktop, a laptop and a tablet) and software.

The system permits typed messaging from the system to the vehicle-based mobile devices using different types of messages including, but not limited to: alert messages (e.g., collision warning); emergency messages (e.g., help request); and orders & commands (e.g., stop!). Two-way casual messaging between the users of the system is also contemplated. All message communications are encrypted.

The system generally has six operational functions: transmitting data to the system servers from a mobile unit associated with a vehicle; transmitting data from the system servers to the mobile unit associated with the vehicle; transmitting data from the system servers to the ground or traffic control station; transmitting data from the traffic control station to the system servers; processing data from the vehicle to produce positional data; and making predictions with an artificial intelligence engine using the processed data. An overview of each of these functions is presented next.

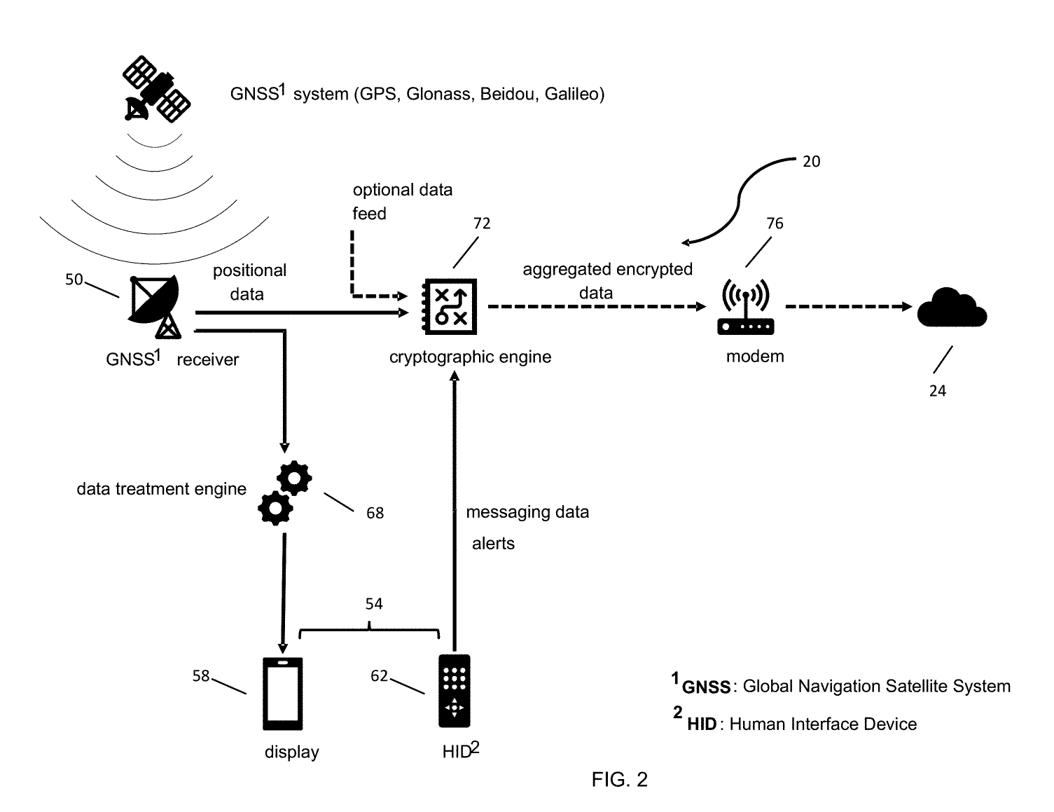

Referring to FIG. 2, the flow of data from a vehicle-based mobile device to the system servers is depicted. In one embodiment of the mobile unit of the system that is associated with a vehicle, the position of the device, and hence the vehicle with which it is associated, is gathered using a built-in Global Navigation Satellite System (GNSS) receiver 50 (such as GPS, Glonass, BeiDou, Galileo). A position update occurs when the time since the last update data transmission exceeds a preset timespan and/or when distance traveled since the last update data transmission exceeds a preset distance value. In addition, the preset values may be modified to meet the requirements of the current case scenario. Such position data may include, but are not limited to, geographic coordinates, altitude, speed, and heading. A Human Interface Device (HID) 54, including an input portion 58 and a display portion 62, is used in the mobile system to send and receive messages. In one embodiment, the input portion includes a simple alert button or a more complex device, such as a keyboard for more elaborate messaging, or both.

Positional data from the GNSS 50 is sent to the HID 54 after being formatted and filtered for display by the data treatment engine 68 associated with the device on the vehicle. Data input through the HID input 58 and positional data is sent to a cryptographic engine 72, before being sent to a communications modem 76 for transmission to the server 24. Depending on the location of the vehicle-based mobile device, the communication link may be any wireless mode, including but not limited to, cellular radio, satellite phone, or internet.

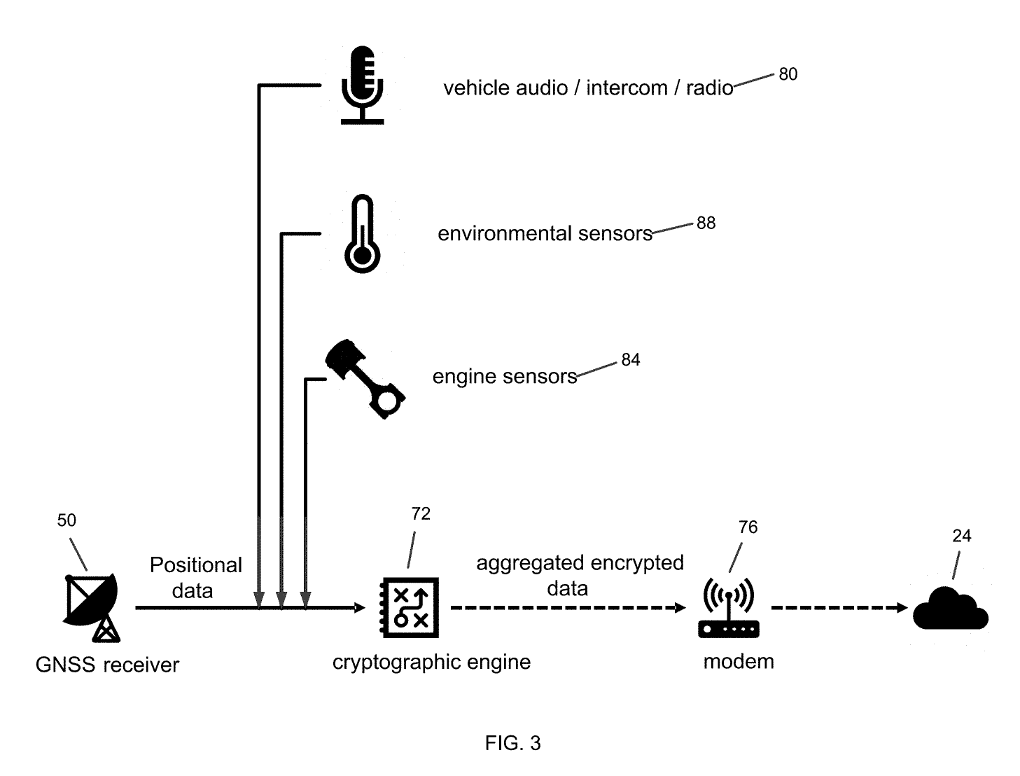

Referring to FIG. 3, in addition to positional data, vehicle data can be gathered by using the expansion port and a converter to allow communication within the vehicle systems (including, but not limited to, Controller Area Network (CAN) bus in vehicles and Aeronautical Radio INC (ARINC 729) bus in aeronautical vehicles). Data gathered through the expansion port can include, but is not limited to, audio communications 80 and mechanical system measurements 84, including, but not limited to, engine revolutions per minute, battery voltage, systems' temperatures, vibration, etc. Environmental data 88 may also be collected including, but not limited to, outside air temperature, air pressure, and humidity level. All these data are combined and again encrypted to be sent to the server by the built-in modem 76.

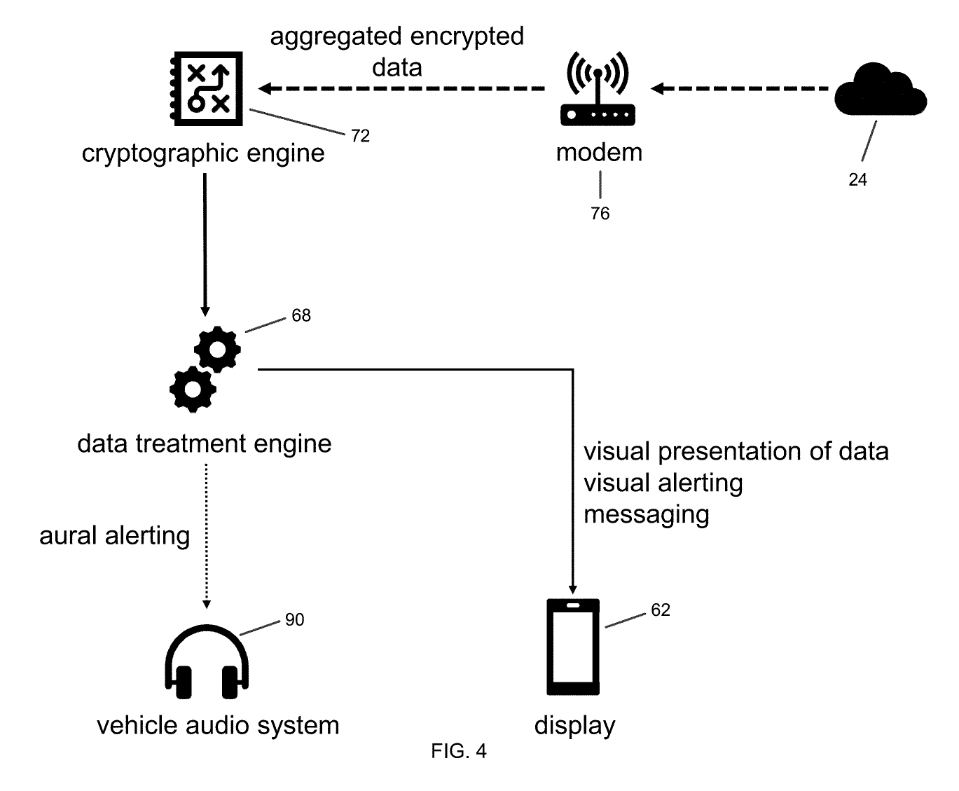

Referring to FIG. 4, in addition to data being sent to the system servers, incoming responses from the system servers 24 are processed to be displayed on the HID display 62 or translated to aural messages or warnings 90 by the data treatment engine 68 after decryption by the cryptographic engine 72. There are currently multiple options for implementing the display portion of the mobile system, which may include, but are not limited to, laptop, smartphone, and tablet implementations.

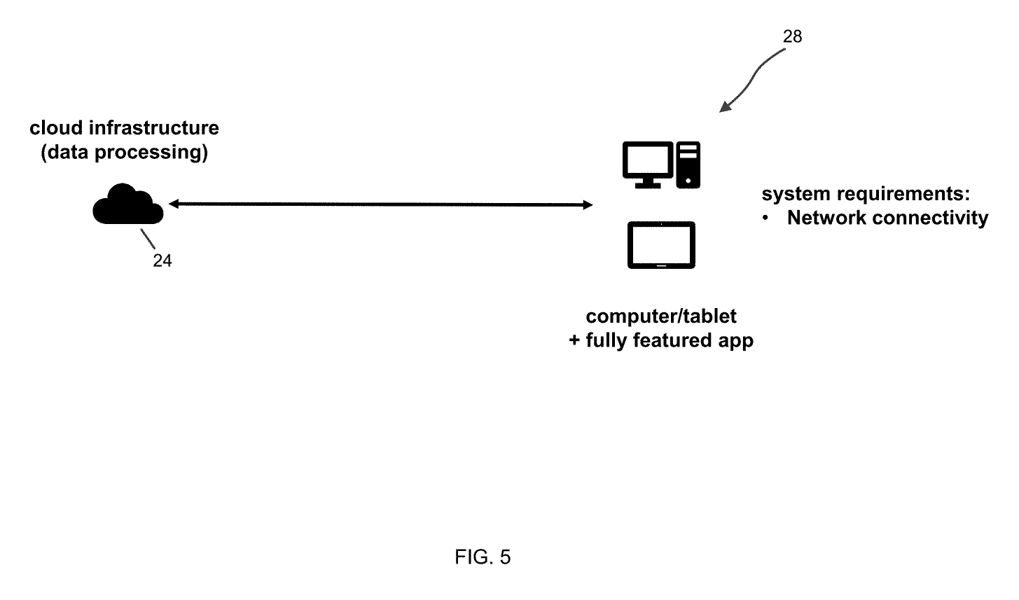

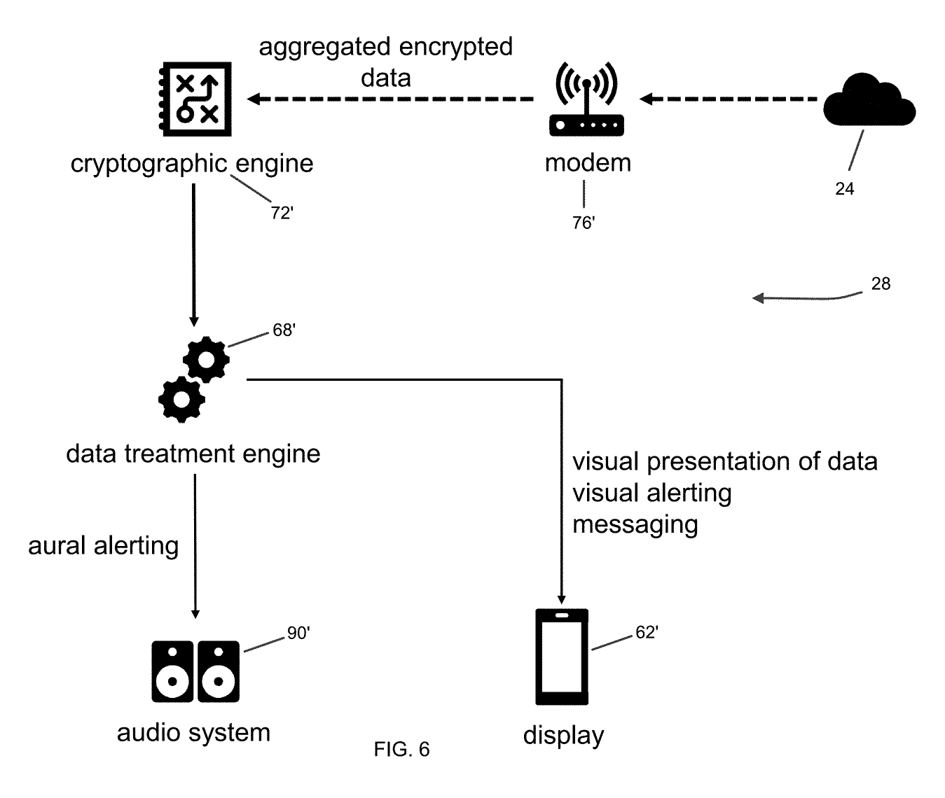

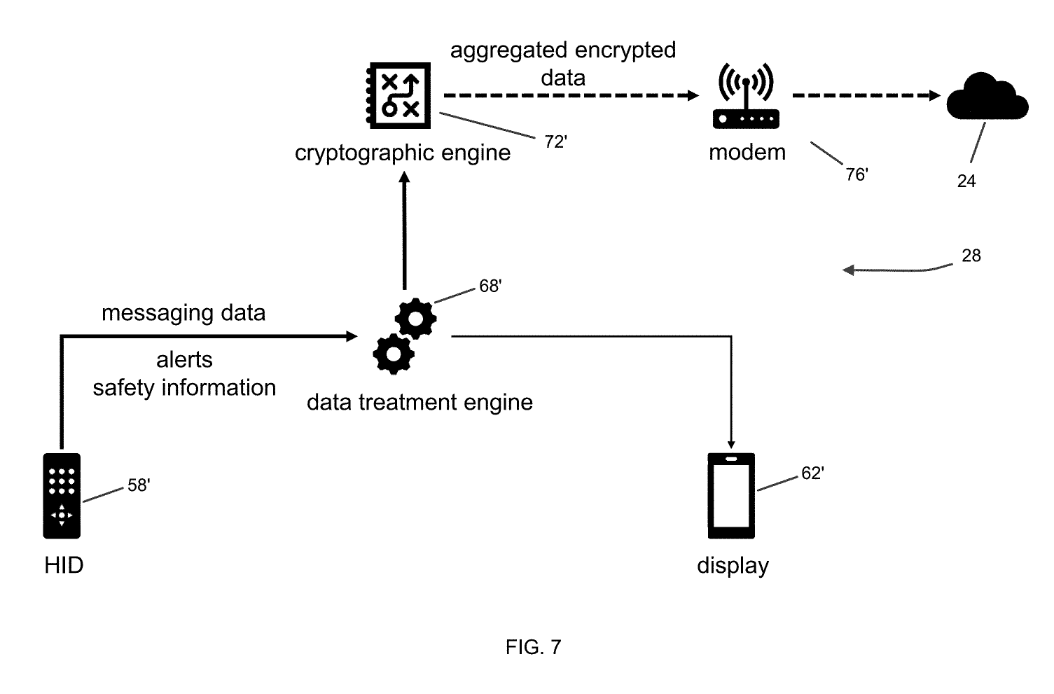

Referring to FIGS. 5 (overview), 6 (incoming data), and 7 (outgoing data), data communications in one embodiment of a ground station 28 are similar to that in the vehicle-based mobile device. The ground station 28 includes a personal computer, smartphone, or tablet with the appropriate software application and network access with internet connectivity. The system will process incoming data for displaying and alerting, while additional features like order/command transmissions and safety information (e.g., weather information) can be implemented through the messaging.

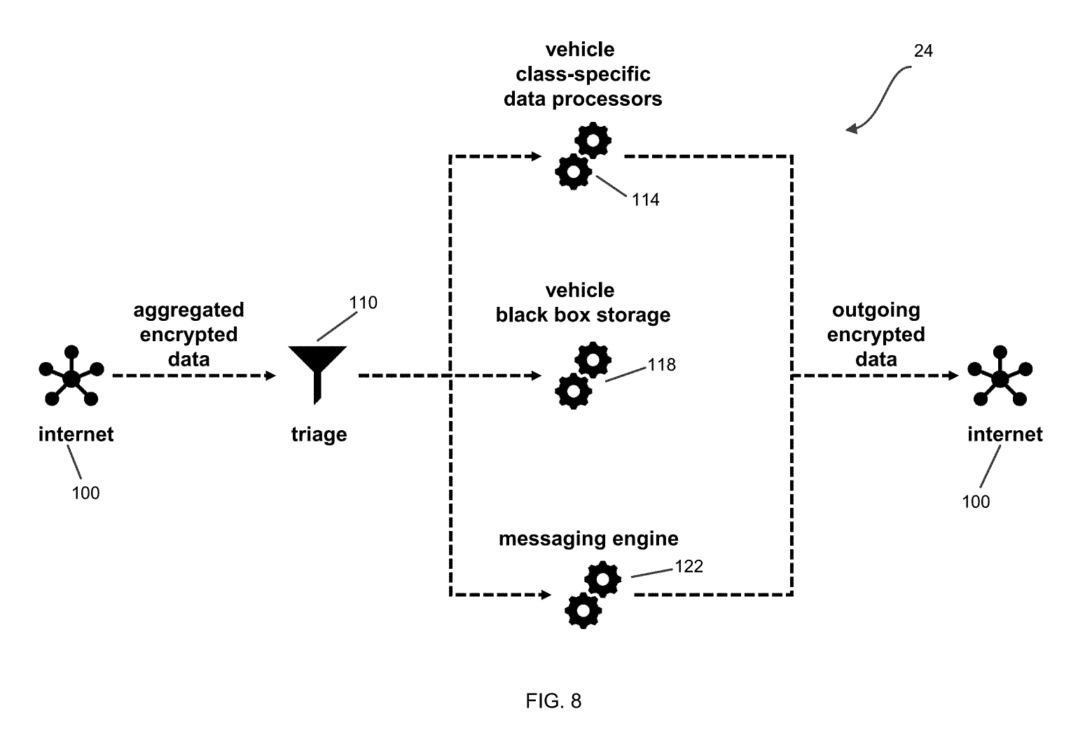

Referring to FIG. 8, the processing in the system servers 24 includes several components. Data received from the network 100 and sent by mobile device associated with the vehicle 20 are separated by a triaging data event hub 110 whose role is to separate data packets by their origin (e.g., aircraft, boats, airport ground vehicle, etc.) and distribute them to the relevant processing units including, but not limited to, vehicle class-specific data processor 114, black box storage 118, and messaging engine 122. The processed data is then returned to the mobile device of vehicle 20 via the net 100. The data is then forwarded to the server with incidents specific to the vehicle server class.

The databases associated with the invention include but are not limited to:

a non-persistent (transient), high throughput database which stores data of devices/vehicles currently using the system. This database stores location and kinematic data including but not limited to longitude, latitude, altitude, speeds, heading, vertical and horizontal GPS precision;

a secure black box database which stores the trajectory data such as the non-persistent database and additional parameters including but not limited to engine parameters, environmental conditions and so on; and an AI database which stores trajectory and additional data for the exclusive use of the AI system. This database serves as a trajectory repository for machine learning.

The black box and AI database use the same data format and contain substantially the same data, although some data that is maintained in the black box database may be removed from the AI if deemed useless in order to preserve storage capacity and performance.

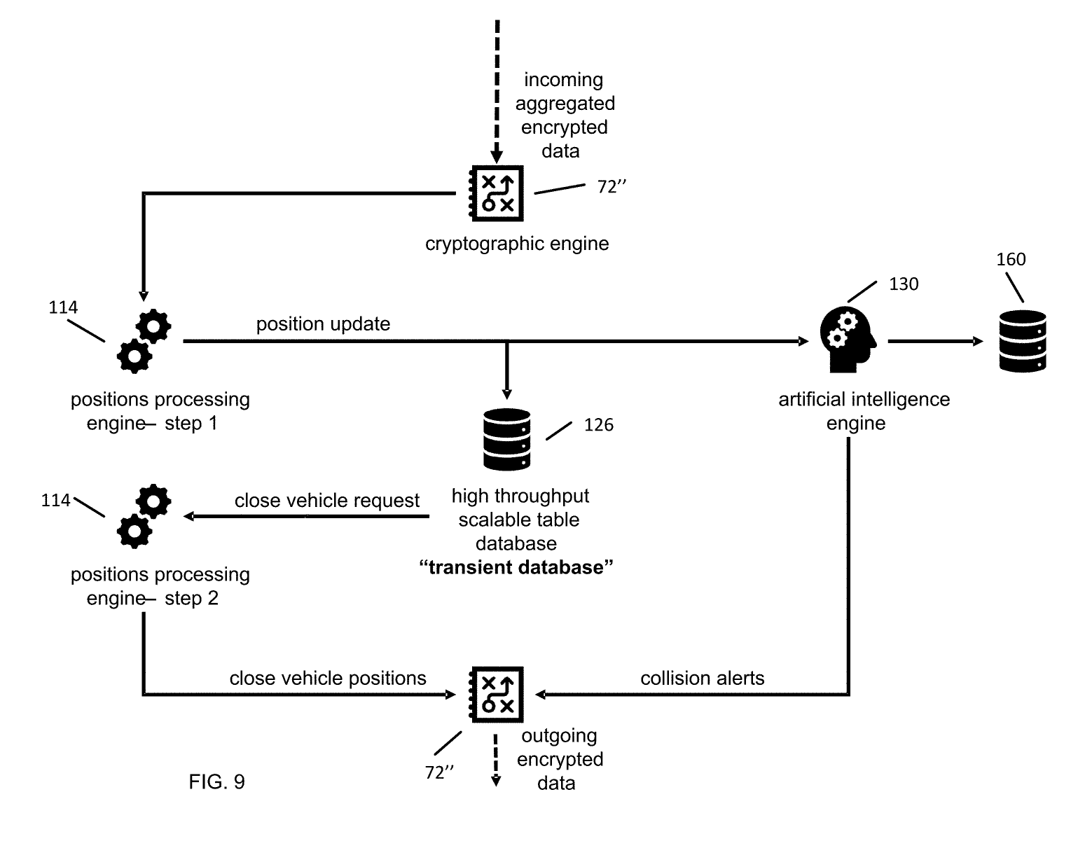

Referring to FIG. 9, the data processors 114 of the server 24 gather positional data from the mobile device of the vehicle 20 and insert or update a non-persistent high-throughput transient database (position database) 126 with incoming data after decryption of the data messages from the vehicle-based mobile device by a cryptographic engine 72″. Positions of close vehicle-based mobile devices in the relevant categories are extracted from the position database 126 in response to the position of the mobile device sending its coordinates or request. The data are formatted, encrypted 72″, and sent back to the current vehicle that sent its position. The position data of other vehicle-based mobile devices in the area is also sent to an artificial intelligence (AI) engine 130 which includes its own AI database 160 of vehicle-based mobile device positions that it uses to generate collision alerts. As mentioned above, the black box and AI database use the same data format and contain substantially the same data AI database. The use of a separate database for the AI engine is for speed of calculation and to avoid concurrency issues.

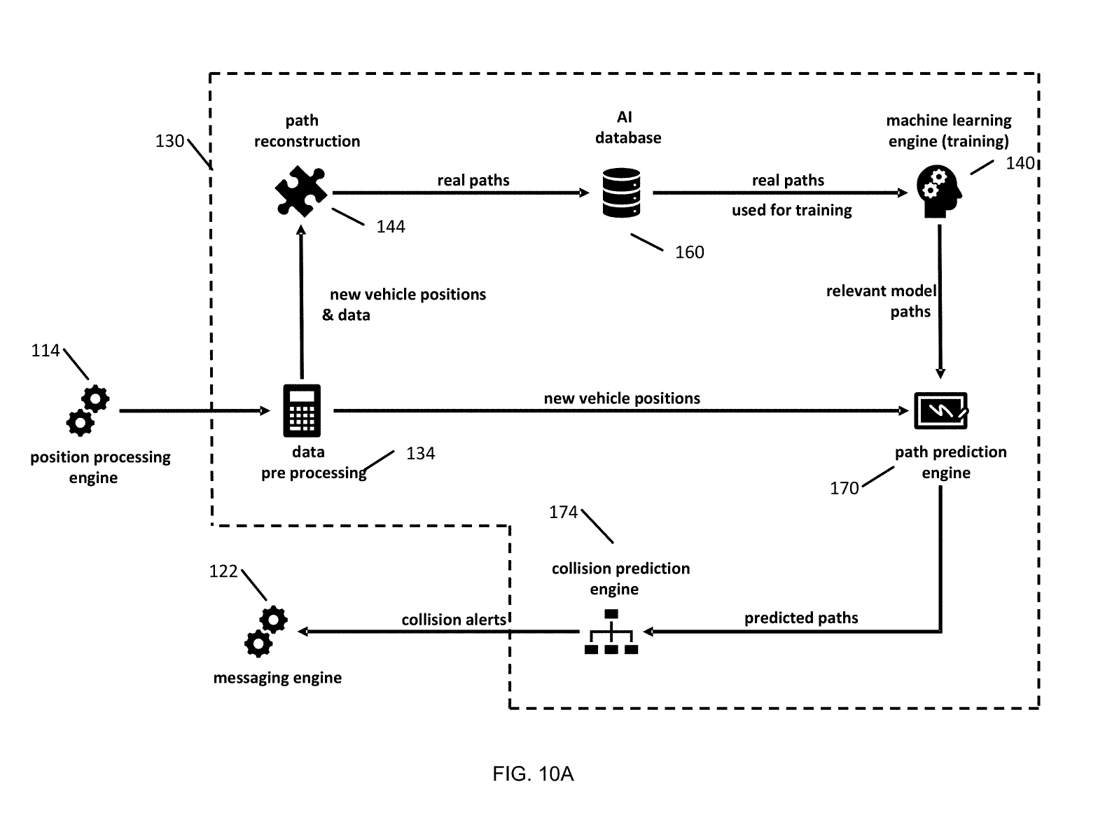

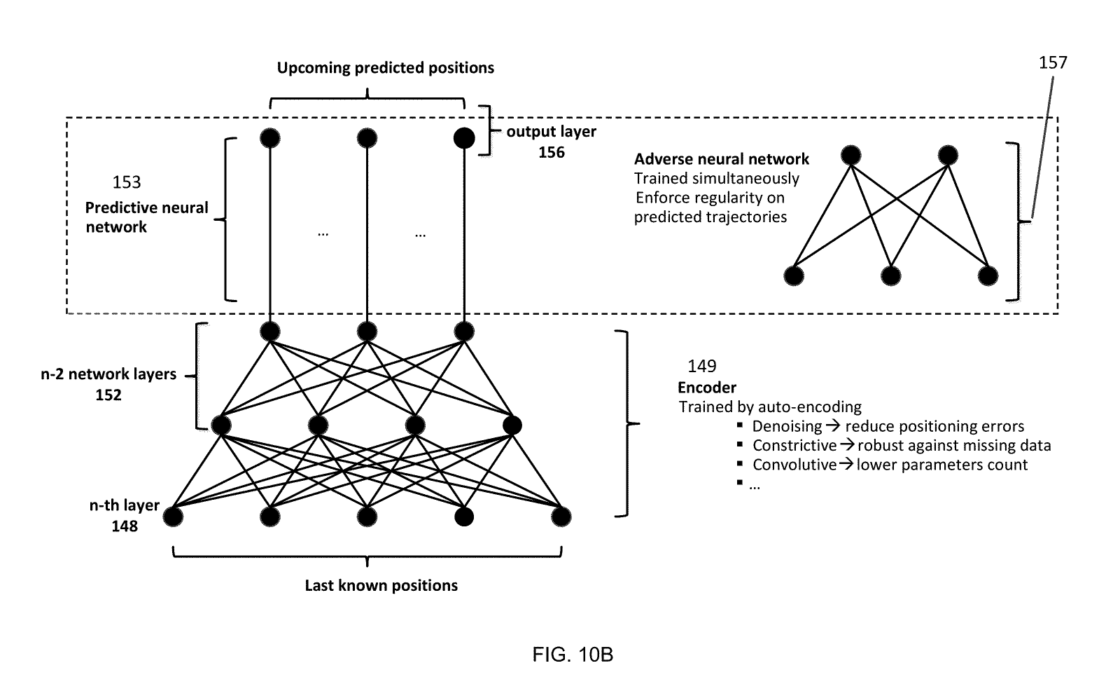

Referring to FIG. 10A, position updates are sent by the position processing engine 114 to the machine learning portion 140 of the artificial intelligence engine 130 whose role is to issue relevant collision alerts. The first step involved in intelligent collision prediction is preprocessing 134 the data in order to construct 144 the actual vehicle paths taken by each of the relevant vehicles. In one embodiment, paths or trajectories are determined for every vehicle-based mobile device visible to the system. These determined paths are categorized according to parameters which can be set differently to suit the current environmental scenario. For instance, airport ground vehicles could be categorized according to their type (luggage cart, fuel tank, fuel pump, mobile stairs etc.) while aircraft are categorized according to their performances (like speed, rate of climb, rate of turn etc.). The close vehicles' information is sent to the current vehicle-based mobile device reporting its position data according to a simple position comparison (e.g., distance is closer than some threshold) as will be described in detail below. Alerts are sent to the relevant vehicles after trajectory prediction only if any trajectory presents a potential collision trajectory.

The resulting trajectories are inserted as a path in the AI database 160 for further use along with performance data from the vehicle transmitting its position. These trajectories are sent periodically to the machine learning portion 140 of the AI engine 130 whose role is to differentiate different scenarios (for instance, an aircraft flying into an uncontrolled area versus an aircraft patterning around an airport) and create model trajectories through training iterations. The calculated model trajectories are used by the trajectory or path prediction engine 170 of the AI engine 130 to provide paths to a collision prediction engine 174 to issue “intelligent collision alerts” that suit the user activity in order to avoid the multiplication of inaccurate or irrelevant alerts which could then be ignored by the user.

FIG. 10B is an embodiment of the learning engine 140 of FIG. 10A. In this embodiment, the learning engine is a multi-layer neural net that includes an encoder 149 that has an n-th layer 148 that is the input layer that includes the last known positions of the vehicle of interest. The encoder is trained by auto-encoding and is de-noising to reduce position errors, constrictive to be robust against missing data and convolutive to lower the number of parameters. The remaining n-2 layers 152 of the encoder are hidden layers that generate signals to a predictive neural network 153 that includes an output layer 156 that supplies a set of predicted positions. An additional adverse neural network 157 is trained simultaneously on the same data to enforce regularity and consistency on the predicted trajectories. Other machine learning algorithms such as fuzzy-logic machines are contemplated.

Each trajectory is stored in each of the databases where, in one embodiment, each record is a Trajectory_Record_Object. Each time a vehicle-based mobile device registers with the system, a new record is created in the transient database. In the black box and AI databases it is added to a list of trajectory records. The record includes a Start_Time to denote the time of registration, the unique vehicle identifier provided by the system, and an empty list of Trajectory_Point_Objects. Each time a new position for the vehicle-based mobile device is received, a new Trajectory_Point_Object is added to the list. Storage of a Trajectory_Point_Object is differential with nullable properties, meaning only changing values are recorded. This saves space in the databases. Certain items, such as the Start_Time and the unique vehicle identifier of the object, cannot be null at registration. Other parameters may have null values.

In some embodiments, other properties are populated in the database when position updates are sent to the system. Some of these properties may be optional including, but not limited to, external data objects which can carry engine parameters. In some embodiments, medical and emergency conditions are optional parameters which are critical for some types of vehicles, such as ground vehicles. Medical conditions may include, but are not limited to, any condition in which a passenger or operator of the vehicle requires immediate medical attention or requires treatment for an injury. An emergency condition may include any condition that requires an alteration or termination of the vehicle's trajectory, such as mechanical failure, poor weather conditions, accidents, and other such incidents. These parameters may be used to inform the control operator (or vice versa) that there is a problem (a mechanical emergency condition for example, or a medical condition if someone is injured) at the device level.

Similarly, End_Time is assigned when the device unregisters itself from the database and is marked as inactive by the system. An embodiment of a Trajectory_Point_Object as stored in a database for one embodiment is:

```
Trajectory_Point_Object
{
long Start_time
long End_time
long Vehicle Unique Identifier
  object List of Trajectory Point Objects
}
Trajectory_Point_Object
{
long Timestamp
  double Latitude
  double Longitude
  short Speed [m.s⁻¹]
  short Heading [degrees relative to true north]
short Altitude [m]
sbyte Horizontal Accuracy [m]
sbyte Vertical Accuracy [m]
boolean Emergency Condition Set
boolean Medical Condition Set
object List of External Data Objects
}
External Data Object
{
enumeration Type of datum
byte array Datum
}
Note on data types:
sbyte: unsigned 8-bit integer
short: signed 16-bit integer
long: signed 64-bit integer
double: 64-bit floating point number
boolean: Boolean data type (true or false)
object: generic data type
```

but other embodiments are contemplated. In one embodiment, time is expressed as a count of 100 nanoseconds elapsed since midnight, January 1^{st} 0001 and does not take leap seconds into account. The Type of Datum is an integer-based enumeration data type allowing for expansion when new sensors or data are added. In the above exemplary record, Horizontal and Vertical accuracy are determined and reported by all GNSS receivers based on the result of error calculations made by many GNSS receivers.

In addition to intelligent collision alerts, the system's algorithms also detect aberrant behavior (e.g., a luggage cart attempting to cross an aircraft taxiway at an airport) if the behavior of the vehicle does not fit the predicted trajectory model obtained from machine learning algorithms. These alerts are sent to the control operator and the mobile user so that appropriate action may be taken. Whether the alerts are sent or not depends on the type of vehicle and/or operator. In an illustrative case of abnormal behavior, the alert could translate in an aural and visual warning at the control operator level and a red flashing light on the device in the vehicle. After encryption, intelligent collision and other alerts are sent through a messaging engine 122 to the vehicle-based mobile device sending position data and to the relevant control operator so that appropriate action may be taken by both.

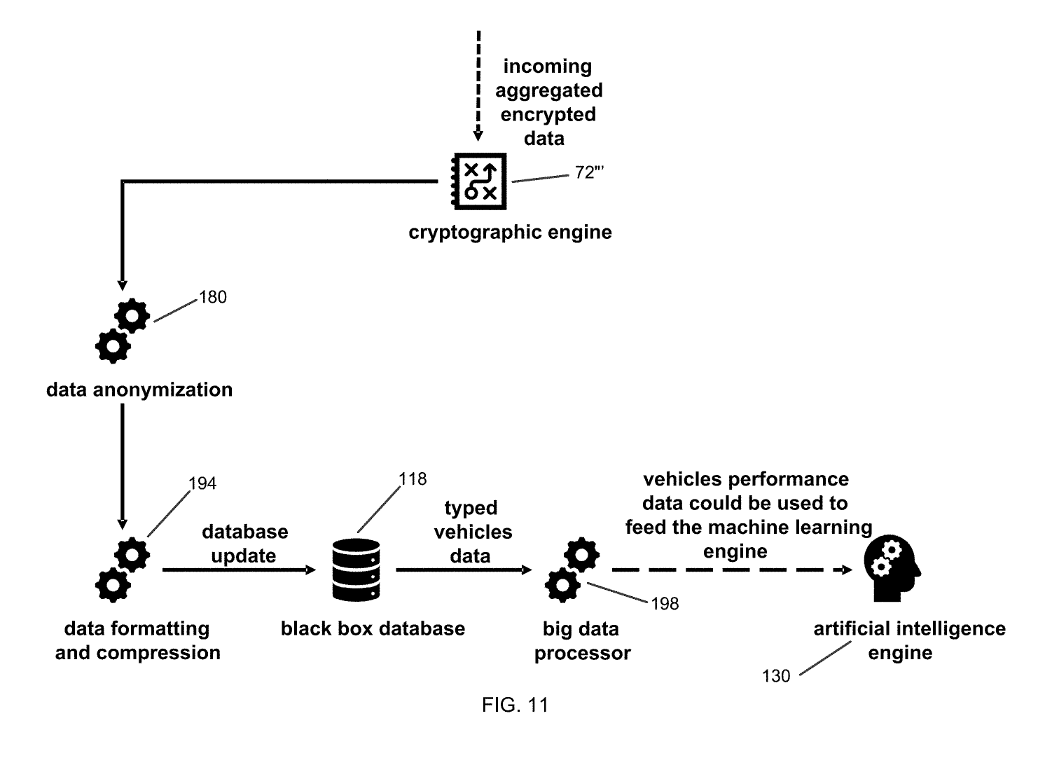

Referring to FIG. 11, in addition to collision avoidance, the system also provides black box vehicle data storage in the black box database 118 in the servers 24. The data used by the black box database in the servers 24 may be the same as the database used in the vehicle black box storage 118. However, the data may be processed by the two devices asynchronously to determine additional parameters that are relevant to the system. In that case, these parameters might be added to the AI database 160 prior to new machine learning training. After decryption 72′″, incoming data are anonymized and any identifying data are removed 180 and replaced with a reference number for privacy concerns. In this way, privacy is maintained until such time as authorities need to correlate the black box data with a specific incident.

After formatting 194, the data is stored in black box database 118 and this data constitutes a virtual black box or flight recorder that can receive all the technical data (position, vehicle, environment) gathered by the mobile system. Each user has the ability to query the database using an appropriate secrecy key or password. As depicted, the big data processor 198 represents all the asynchronous processing that may be done on a complete storage database (the “black box database”) in order to determine, through AI and big data techniques, if additional parameters might be relevant for use with the machine learning algorithms in 140. The data may then be sent to an artificial intelligence engine 130 for additional analysis, such as determining predictive trajectories to determine abnormal behavior and enhance collision and risk assessment algorithms.

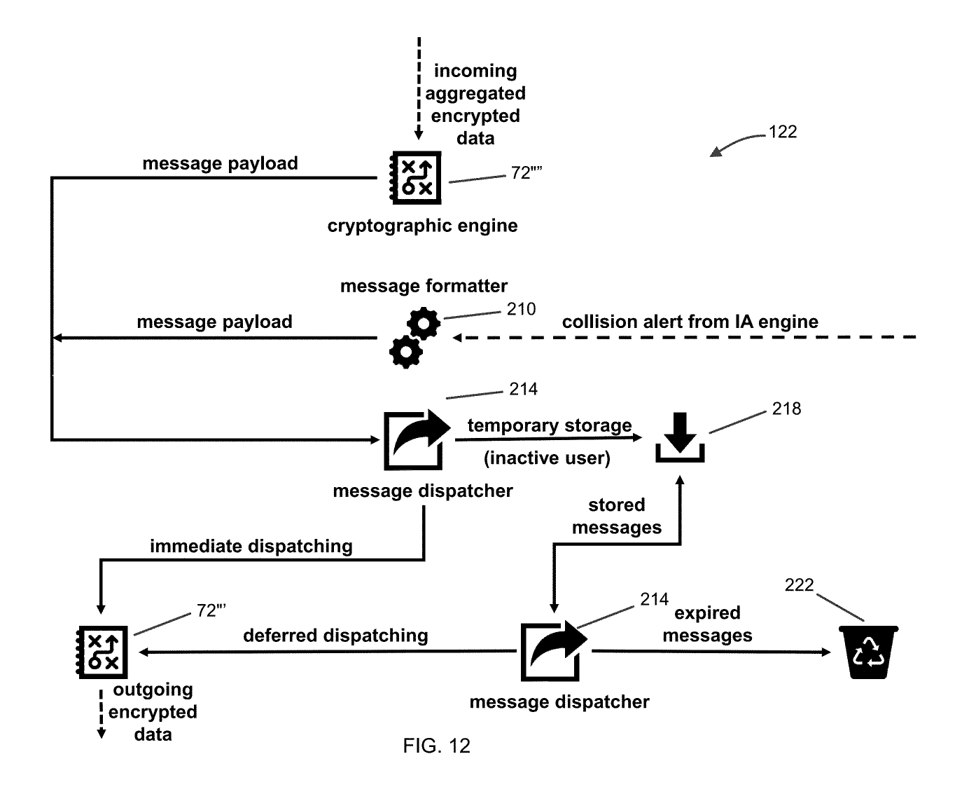

Referring to FIG. 12, the messaging engine 122 works by dispatching 214 incoming messages to the relevant user after encryption 72′″, storing the message 218 (while the user is inactive) for additional dispatching 214 or discarding the message 222 if it has expired because the set expiration time has been reached. In an embodiment of the present system, an inactive user is a user that may be temporarily offline (for instance, having no cellular connection) and therefore not using the system by the time the message should be sent (rendering the device as “off”).

In an embodiment of the present system, messages are stored and discarded according to their specific time to “live” (TTL). For example, a collision alert message will have a short TTL because it is generated in real time and will be generated anew during the next pass of the AI engine. On the other hand, weather or ATIS messages have a longer TTL since an ATIS message has a validity of 1 hour according to current regulations. Casual messages may have an infinite TTL (for example, 365 days in one embodiment). Expiry time is set with different factors. For example, a “STOP” order has no expiry date, has an infinite TTL, and can only be revoked by a subsequent GO order, while a collision alert by its nature is only temporary. A new collision alert is sent at every computing cycle until the trajectories are no longer colliding. After formatting 210, the messaging engine also dispatches the collision and other alerts issued by the artificial intelligence part of the data processor.

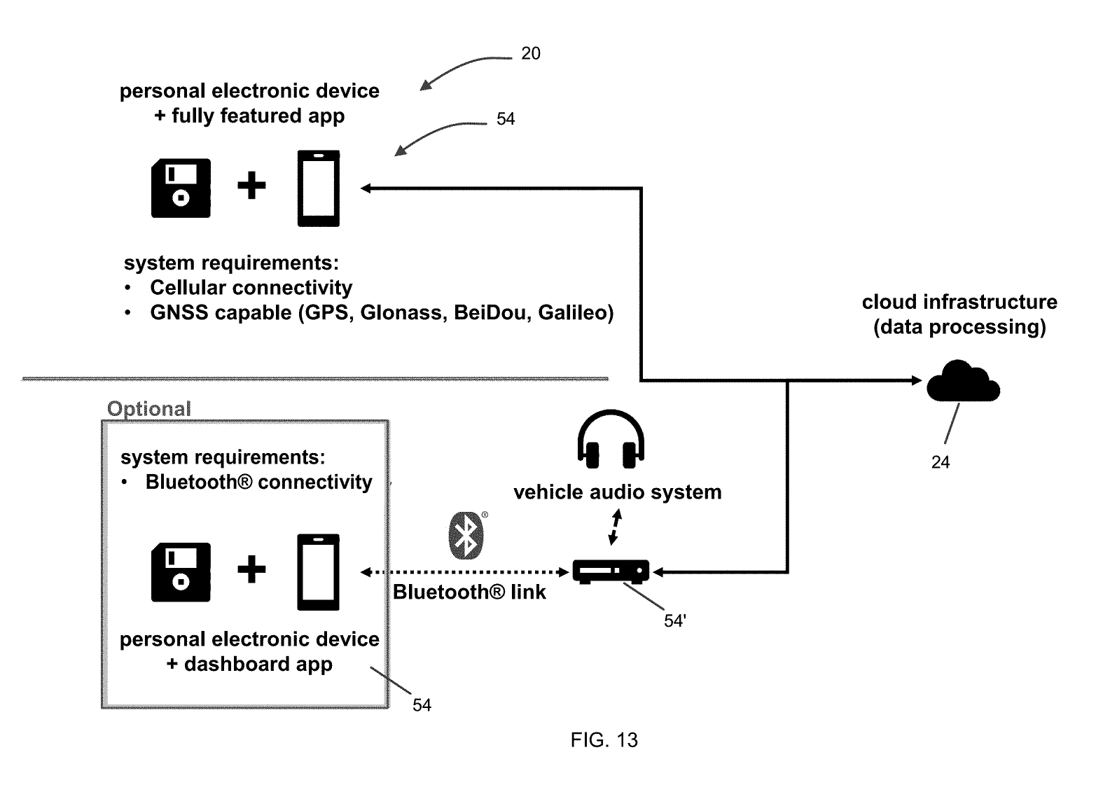

Referring to FIG. 13, for use in less critical situations, the vehicle-based mobile device 54 can be a personal electronic device such as a smart phone with the installed software application, provided that the device 54 comes equipped with a GNSS receiver and cellular connectivity. For more important uses, the vehicle has an “always-on” vehicle-mounted device 54′. The device 54′ encapsulates the basic safety features of the smartphone version discussed above (i.e., data gathering and transmission, and aural alerts through analog audio) and is equipped with Bluetooth connectivity to allow for a more advanced use scenario with a personal electronic device-installed software application 54. This specific software application provides a display for the system, increased display flexibility and user friendliness, but remains an optional way to display data.

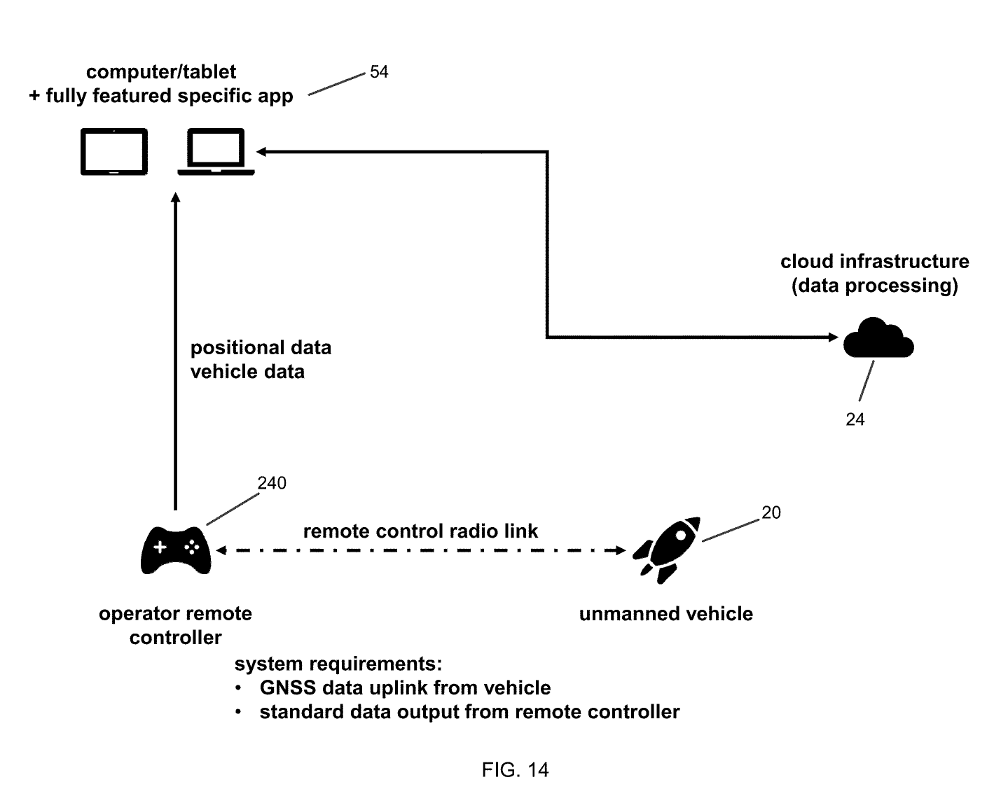

Referring also to FIG. 14, the system can also be used with unmanned vehicles such as air and surface drones, provided that the unmanned vehicle can send its geographical coordinates to the remote controller 240 and that the remote controller provides a way to access these data (standard communication port). The data can be sent to the server databases, permitting the unmanned vehicle to be visible on the virtual radar and enhancing the unmanned vehicle operator's situational awareness through the use of an application which combines the features of the mobile application and the ground application described above.

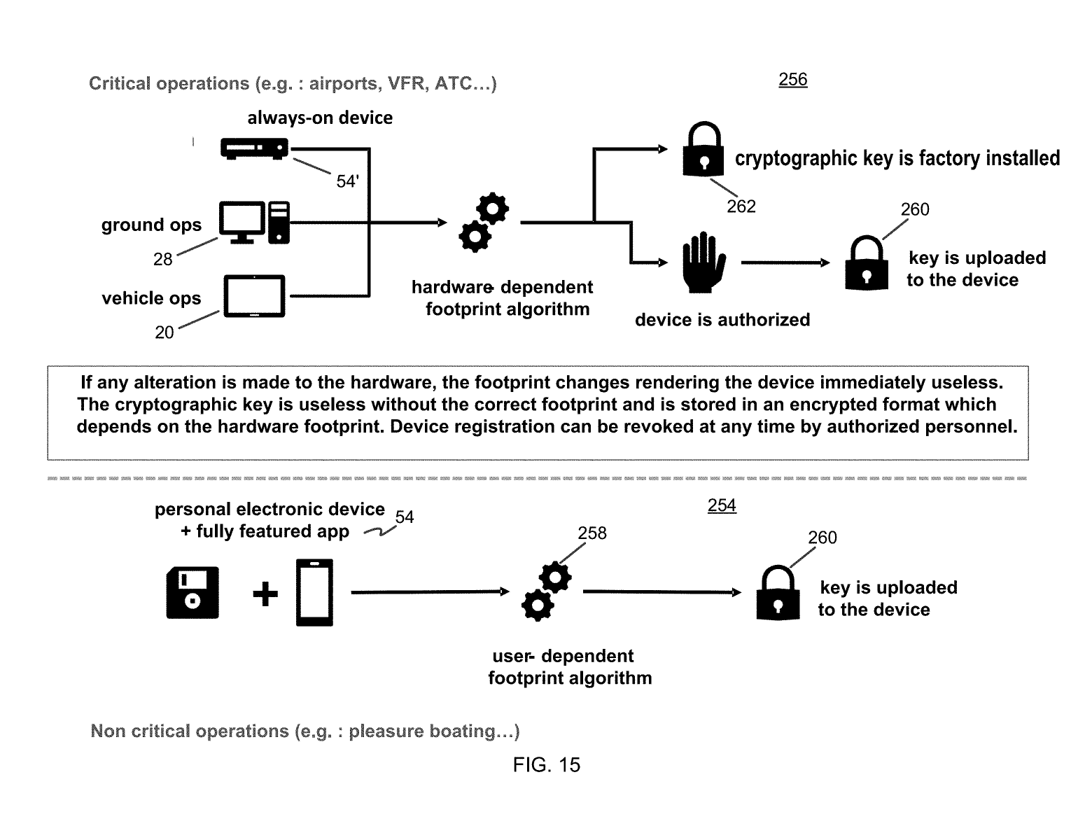

Referring to FIG. 15, encryption and security are achieved by leveraging an industry standard encryption algorithm. Each device/software application needs to be provisioned with a cryptographic key and is identified by a unique identifier. There are two general types of operation.

For casual operation 254, such as pleasure boating, provisioning of the user account is done automatically after authentication with a known identity provider (Microsoft, Google, Facebook, and Twitter, for example). The hardware identifier is replaced by the Unique User ID given by the identity provider as altered by a specific algorithm. This is done in the same way that smart phone operating system developers do not allow the use of a permanent unique identifier for the user. Instead, the unique identifier is derived from persistent data provided by the authentication provider and altered (by hashing and salting, for example) to generate a temporary unique identifier.

For critical operation 256 such as aircraft control, the identity of the device is the result of an algorithm that uses hardware descriptors as input values. Any time the hardware configuration is tampered with, the identity is changed and the device can no longer register itself with the servers. If an always-on vehicle-based installed mobile device 54′ is used, the cryptographic key 262 is factory installed and a hardware-derived key is used to encrypt it. If a tablet or similar device is used, the device needs to be provisioned by personnel using a specific software application installed on a computer which will upload the cryptographic key 260 to it.

Because no system is hacker-proof, any device or account can be disabled at any time by personnel to prevent a compromised system from providing erroneous data to the servers. Automated detection can be used to determine a compromised system or the compromised mobile system can have its authorization (ID and Security Key) revoked by authorized personnel once the compromise of the system has been detected.

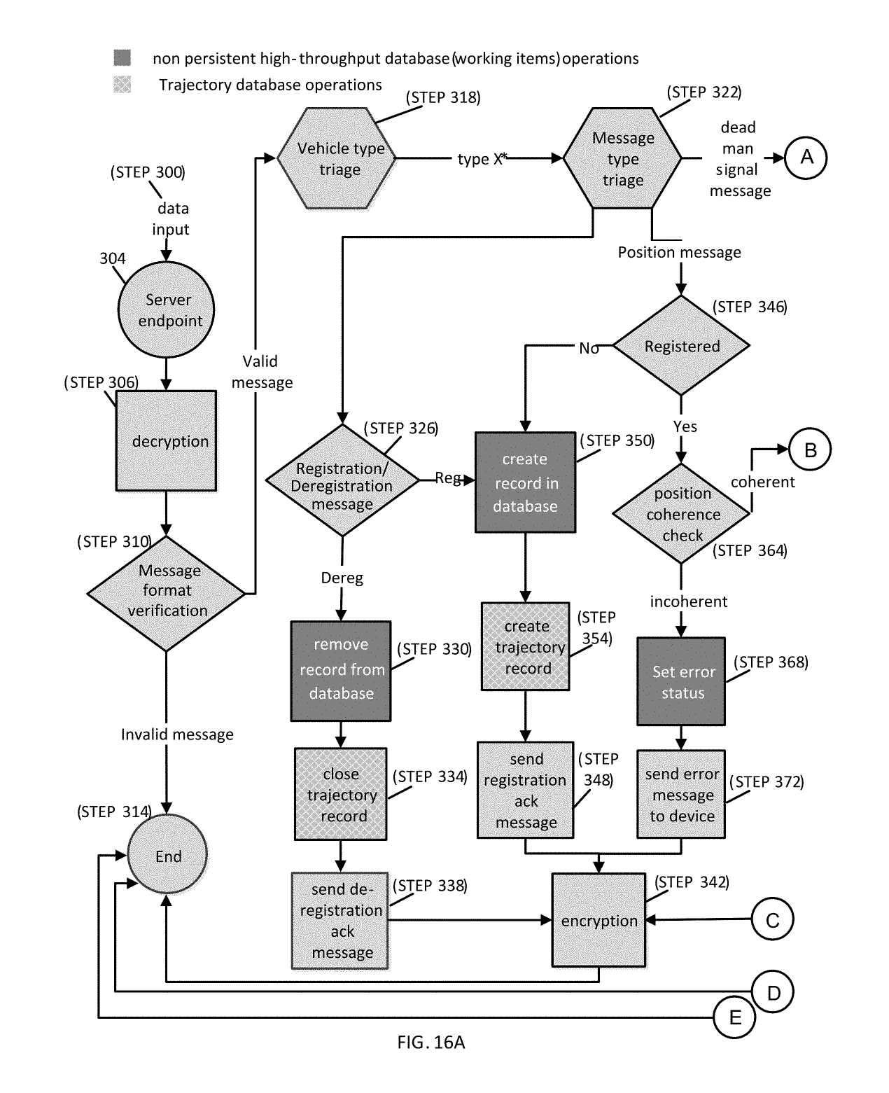

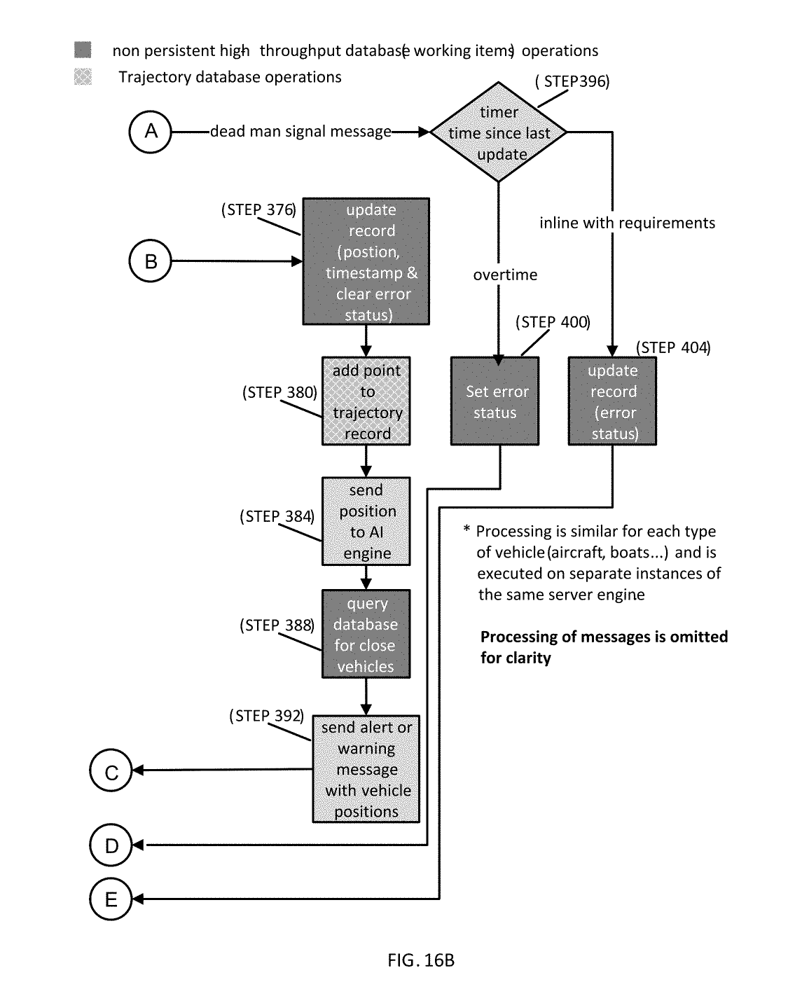

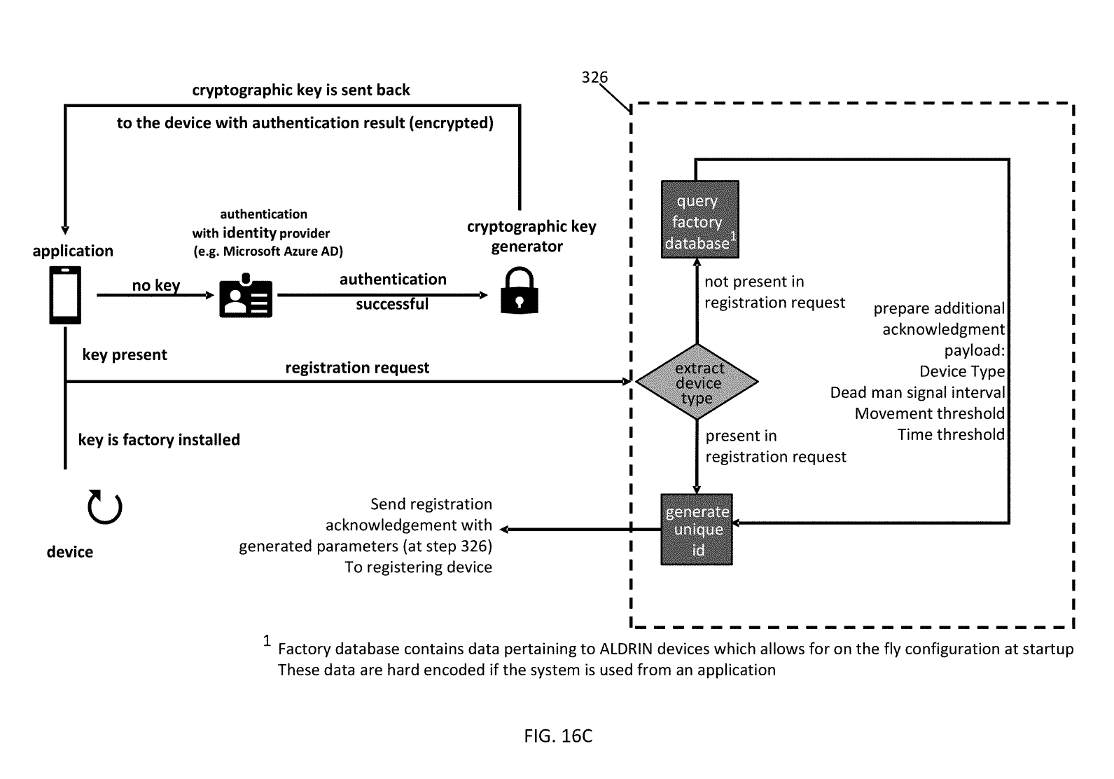

In more detail and referring also to FIGS. 16A and 16B, the operation of the system will now be described in more detail. When a mobile device 54 sends a message to the system, data is sent (step 300) by the device to the system through the server endpoint 304. The system decrypts the data (step 306) and determines whether the message has the proper format and hence is a valid message (step 310). If the message is determined to be invalid, the message is ignored (step 314) and the system waits for the next message (step 300).

If the message has the correct format and is a valid message, it is examined by a triage module 110 (FIG. 8) to determine (step 318) what type of vehicle is associated with the vehicle-based mobile device that sent the message. This triage function allows messages from various different types of vehicles or things, such as boats, aircraft, land motor vehicles, and passive carriers such as movable cargo carriers and pallets or even individuals carrying or wearing smart technology, such as a smart watch, to be handled differently.

Next, the type of message is determined (step 322). If the device is connecting to the system for the first time or is shutting down, it sends, respectively, a registration or deregistration message to the system. The system determines whether the message is a registration or deregistration message (step 326) using a flag in the message.

Referring also to FIG. 16C, in the case of registration, the temporary database is queried to return the ID of the vehicle-based mobile device if it exists in the database. If the message is a registration message and the device is already registered in the database, the system assumes that the device did not deregister properly. If the device does not transmit within a predetermined amount of time in the ordinary course of position reporting, the system deregisters the device. If the vehicle-based mobile device is not present in the database, the system assumes the vehicle-based mobile device has not been registered previously and a new unique ID is generated and the device is added to the database.

If the message is flagged as a deregistration message, the system removes the record of the device from the high throughput transient database (step 330) and closes (step 334) other records associated with the device, such as a trajectory record from the AI database 160 discussed below. Although a record is closed in the black box database, the data is maintained in the database as an archived record. More details of the registration and deregistration process are also discussed below.

Once the records are closed, the system sends an acknowledgement message (step 338) to the device acknowledging that it is no longer registered. This allows any device, which requires an acknowledgement in order to shut down, to complete its shut down process. The acknowledgement message is then encrypted (step 342) prior to being transmitted. The system does not require any response before the process shuts down (step 314) and awaits a new message (step 300).

If the device is not registered in the database, the system creates a record in the high throughput transient database 126 for that device (step 350) and creates a trajectory record in both the black box database and the AI database 160 in parallel (step 354) to track the movement of the vehicle and to predict the vehicle's future movement. Once the two records are generated, the system sends an acknowledgement message to the device (step 348) and encrypts (step 342) that message prior to sending it to the vehicle-based mobile device. The system then awaits a new message (step 300). The creation of a new device record in the database is described in further detail below. A record in the black box or AI database is modeled after the Trajectory Record Object element described above with regard to the transient database. This record is a collection of the last values received from diverse messages pertaining to the vehicle-based mobile device (including but not limited to position, speed, and heading).

If the message type is not a registration or deregistration message, the system determines (step 322) if the message is a position message. In one embodiment, all messages are JavaScript Object Notation (JSON) representations of C# classes. If the message is a position message, the system first checks to determine if it is from a registered vehicle (step 346). If not, the system first takes the steps to create the necessary records in the high throughput transient database 126 (step 350) as described previously.

If registered, the trajectory record in the AI database 160 is read so that a positional coherence check can be performed (step 364). A positional coherence check determines that the positional data just received is reasonable when compared with the last positional information. For example, if the two positions are one hundred miles apart, the time between the two measurements is one minute, and the device is associated with a truck, the velocity of the truck (six thousand miles an hour) is obviously erroneous. In some embodiments, the limits are drawn arbitrarily according to usual behavior of the given vehicles. If the measurement is determined to be erroneous, the device record is flagged in the high throughput transient database 126 as being in error (step 368), an error message is constructed (step 372) and encrypted (step 342) before being sent to the vehicle-based mobile device. In some embodiments, the error message (step 372) is sent as a message which contains an error code and a timestamp. For example, error codes include but are not limited to: Abnormal position (e.g.: latitude or longitude=0.0); Abnormal speed (speed too high); Abnormal altitude (too low or too high); or Other error.

If the positional coherence check is acceptable, the vehicle-based mobile device's high throughput database 126 record is updated with position, timestamp and error status (step 376) and the vehicle's trajectory record in the AI database 160 is updated (step 380). The position of the vehicle is also sent to the AI engine to search for potential collisions (step 384) as discussed below. The high throughput database 160 is queried for vehicles within a predetermined distance of the current position of the current vehicle (step 388). The query returns a display of close vehicles. The AI engine may also return a close warning if these vehicles are inside the “protection volume” as discussed below. If there are vehicles within the predetermined distance of the current vehicle, a close vehicle warning is generated (step 392) and encrypted (step 342) before being sent to the current vehicle.

For each registered vehicle, the system maintains a keep-alive timer status. This system measures the amount of time since the last position message was received (step 396). If the amount of time since the last position message exceeds a predetermined limit, the device is designated to be late in transmitting and the system sets the device's status in the high throughput transient database 126 to error (step 400). The data are encrypted prior to sending and decrypted accordingly. Generally, error conditions are not sent to a device because they usually occur when the device is temporarily offline or has incorrectly shutdown. If the time since the last position update is not in error, the status of the device is recorded in the high throughput transient database 126 before waiting for the next message (step 304).

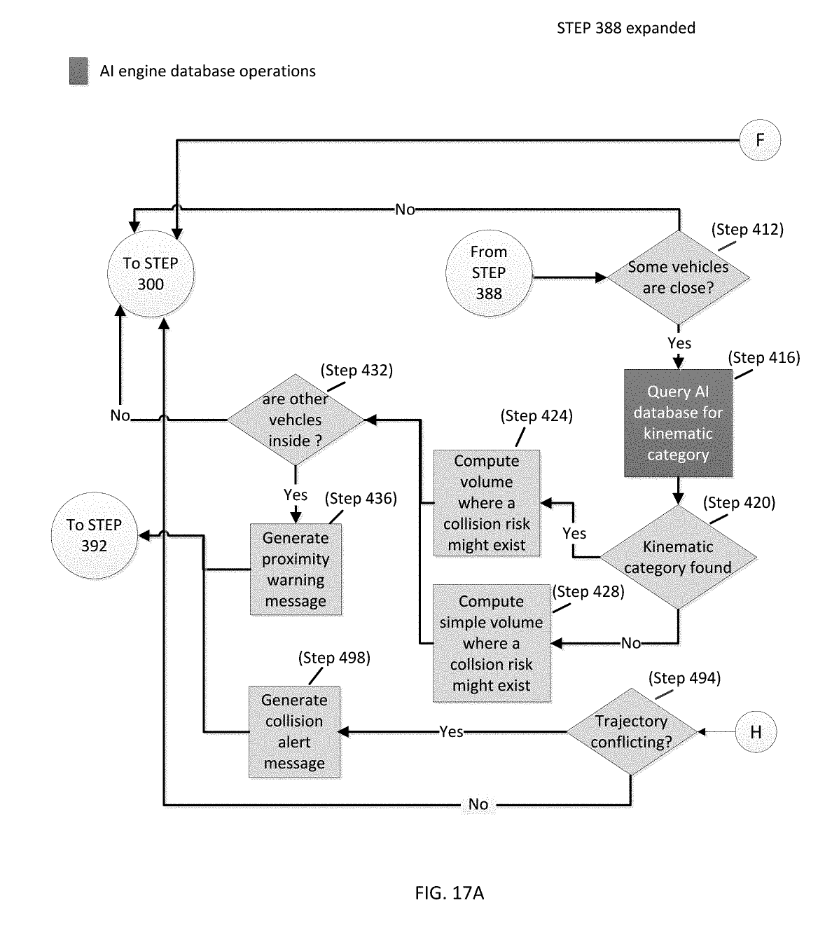

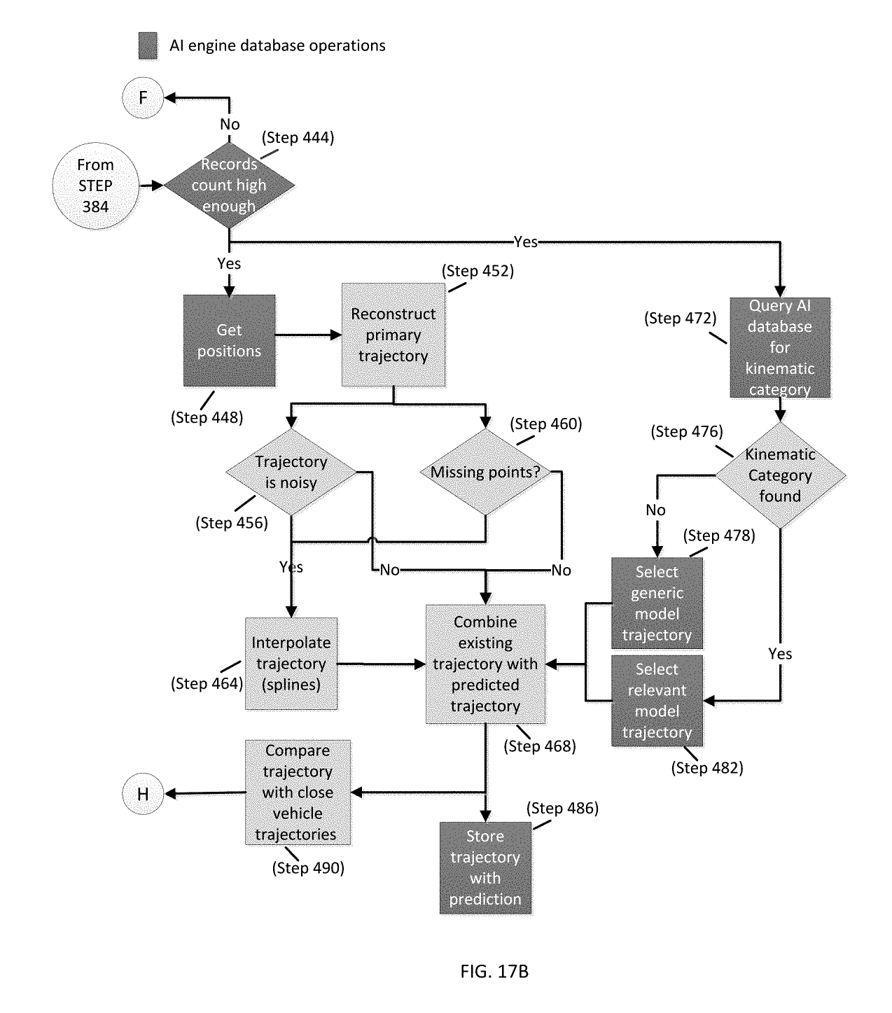

Referring to FIGS. 17A and 17B, the details of step 388 of FIG. 16B is shown. The position database is queried and a determination (step 412) is made of whether any other vehicles are close. In some embodiments, the minimum distance permitted between the vehicle and another object is determined according to the following formula:

Minimum Distance=[Acceptable time of reaction to avoid collision or danger]*[Mean speed of given vehicle type]

If two vehicles are moving in proximity to one another and there is a large difference between their speeds, their closing speed may be used to determine minimum distance. If there are no close vehicles, the algorithm returns to step 300 to obtain a new position for the vehicle being monitored.

If there are other vehicles close to the current vehicle, the AI database 160 is queried (step 416) for the kinematic category of the close vehicle. Kinematic category is determined by the machine learning algorithm which groups vehicles according to various parameters like speed, capacity of acceleration, rate of turn, etc. This classification is dynamic and the parameters considered might vary as the amount of data for the model training grows. The kinematic category of each vehicle is then determined (step 420). In some embodiments, vehicles that are closer than a predetermined number of miles (depending of the type of vehicles considered (412), for instance, 20 miles for aircraft, 100 meters for ground vehicles on airports) are considered close vehicles. The kinematic category of these vehicles is retrieved if they exist (416)

If the kinematic category is found, the system computes (step 424) a volume in which a collision risk might exist using the parameters pertaining to the kinematic category (mean speed, capacity for acceleration, capacity of going backward, max rate of turn, etc.) and the volume resembles a droplet shape. If the kinematic category is not found, the system computes (step 428) a simple volume in which a collision risk might exist when the vehicle has not been classified (such as new kind of fast aircraft with higher rate of turn than any other aircraft). In this case, the protection volume is a simple sphere. In either case, the system then determines (step 432) if there are other vehicles within the volume. If there are no other vehicles within the volume, the program returns to step 300 to receive a position update. If other vehicles are within the volume, the system generates a proximity warning message (step 436) and sends a message to the vehicle being monitored (step 392, FIG. 16B).

When a new position (step 376, FIG. 16B) is acquired, in addition to querying the AI database for close vehicles, the system adds to the position information to the current vehicle-based mobile device's trajectory record (step 380). The system then determines if there are a sufficient consecutive number of position entries (points) in the AI database 160 (step 444, FIG. 17B) to calculate a trajectory for the current vehicle. If there are sufficient numbers of position entries, the system then collects the entries (step 448) in the AI database 160 and generates a primary trajectory (step 452). In some embodiments, the primary trajectory is an ordered list of data points that have been recorded for the vehicle during the current session (after last registration). If the trajectory is noisy with data points scattered along an ideal trajectory (for example, if the GNSS receiver being used has significant variations in precision (step 456) or if there are missing points in the trajectory (step 460), the system then applies a spline interpolation of the trajectory (step 464). If the trajectory is not noisy (step 456) and if there are no missing points (step 460) or if there is a spline fit (step 464), the result is the input to a module to combine the existing trajectory with the predicted trajectory (step 468) from the AI engine.

Further, if the number of records is determined to be sufficient to calculate (step 444) a trajectory, the AI database 160 is queried (step 472) for the kinematic category of the vehicle being monitored. If the kinematic category queried (step 476) in the AI database 160 is not found, a generic model trajectory is selected (step 478) for the trajectory prediction step by the AI engine. If the kinematic category is found in the AI database 160, a relevant model for the category is selected (step 482). A model is a set of parameters determined by the AI system in the course of training that will predict the trajectory being taken by the device.

The combination of the existing trajectory and the predicted model trajectory (step 468) is stored in the AI database 160 (step 486) and the combination trajectory is compared (step 490) to the trajectories of other close vehicles. The combination trajectory and the trajectories of the other vehicles are examined to determine if they conflict in time and space (step 494) and so will result in a collision. If they conflict, a collision alert message is generated (step 498) and sent (step 392, FIG. 16B) to the monitored vehicle. If there is no conflict, the algorithm obtains the next position location for the monitored vehicle (step 300, FIG. 16 A).

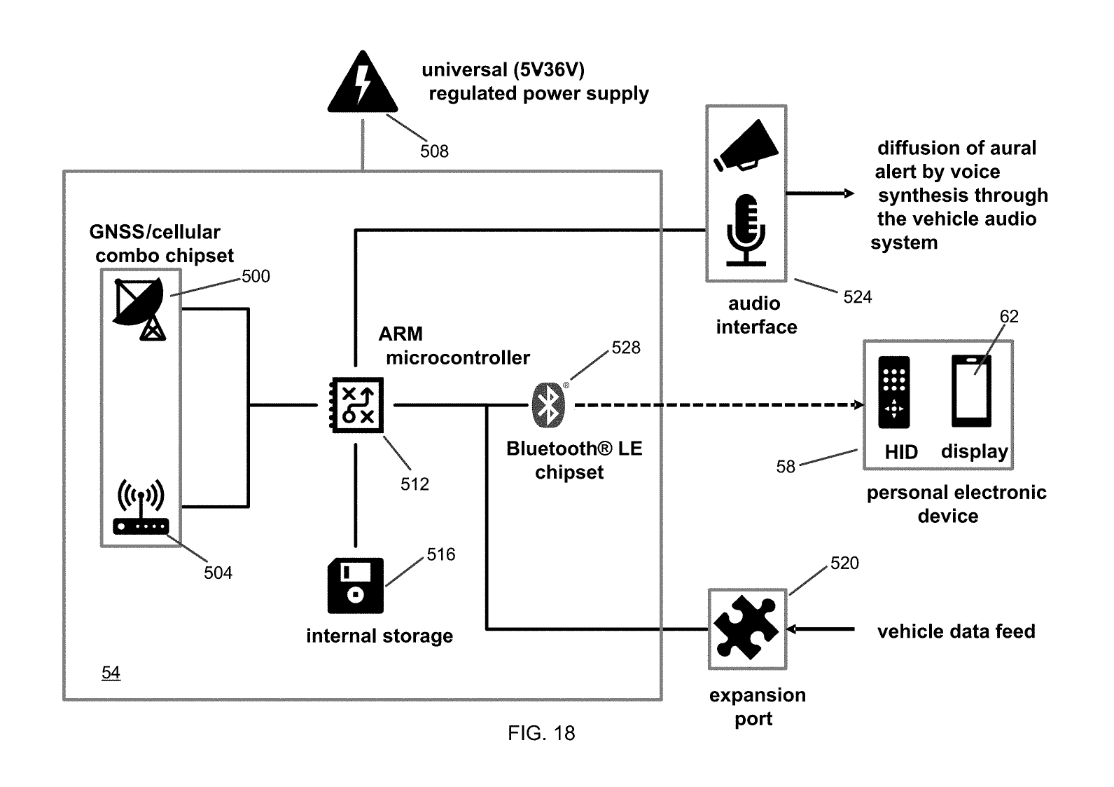

Referring to FIG. 18, an embodiment of the hardware of an always-on vehicle-based mobile device system is shown. The device 54 includes a GNSS 500/cellular modem 504 chip set supplied by a power supply 508 adapted for the vehicle into which it is being placed. A dedicated microcontroller 512 with internal storage 516 receives data from the mechanical systems through a port 520 and an audio interface 524. The device 54 outputs audio signals through the audio interface 524 and receives input and displays output through the human interface 58, 62, respectively, communicating through a Bluetooth wireless link 528. In another embodiment, a keyboard and display are hardwired to the device through the expansion port 520.

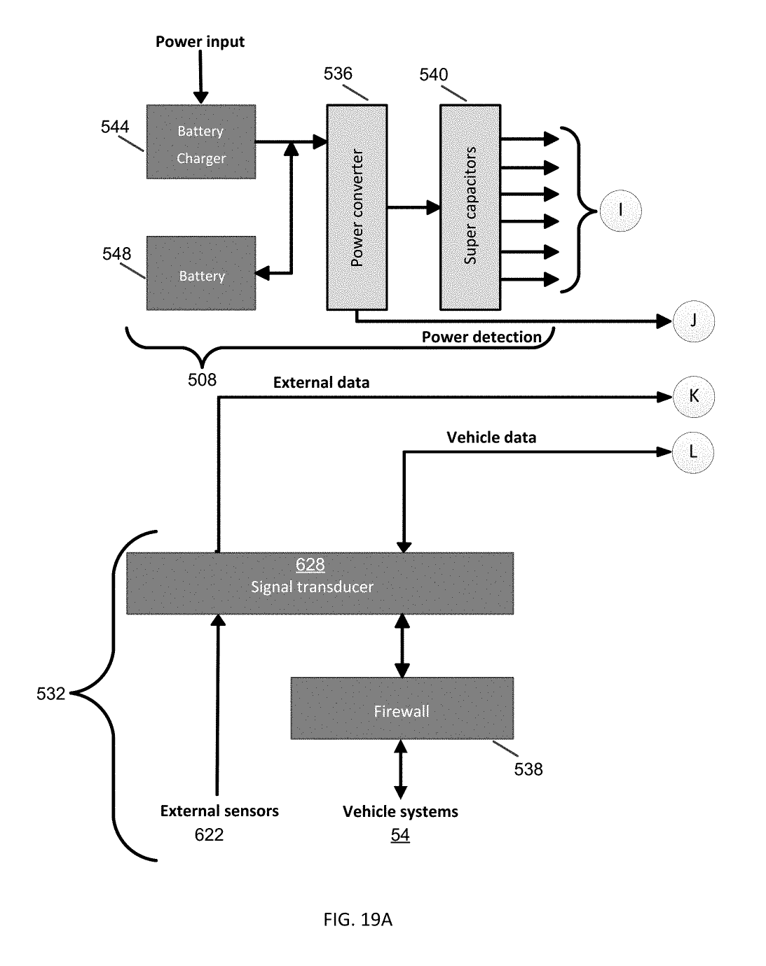

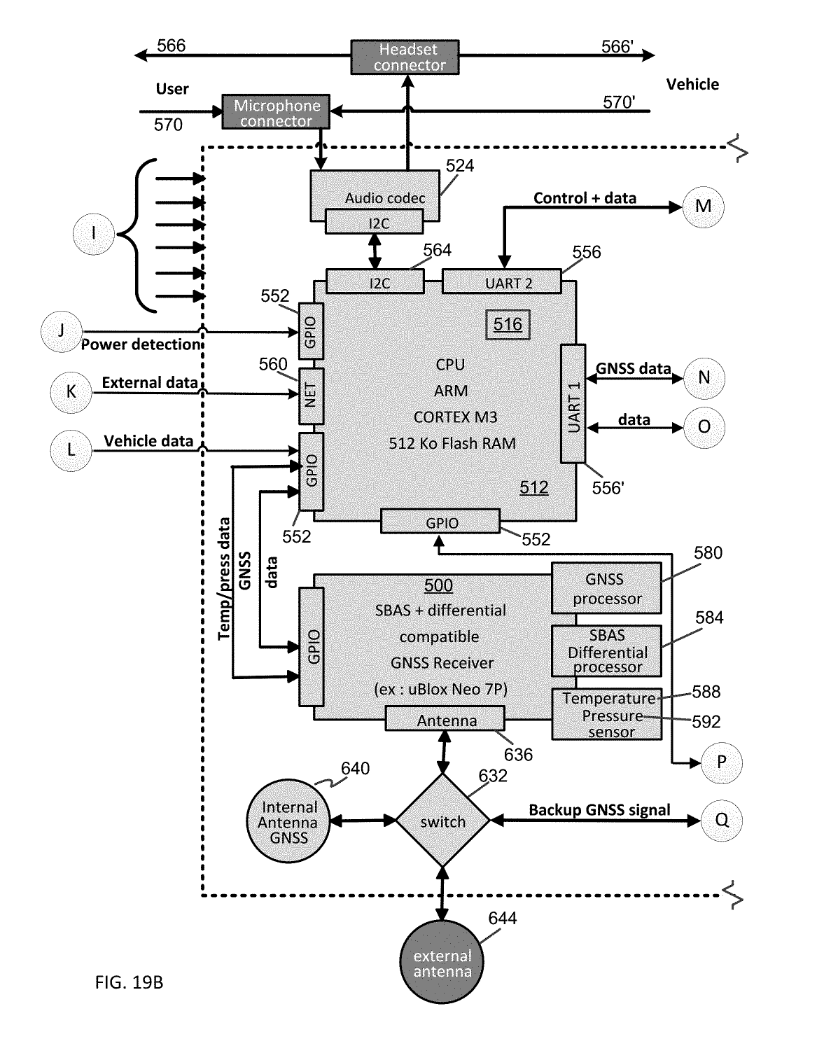

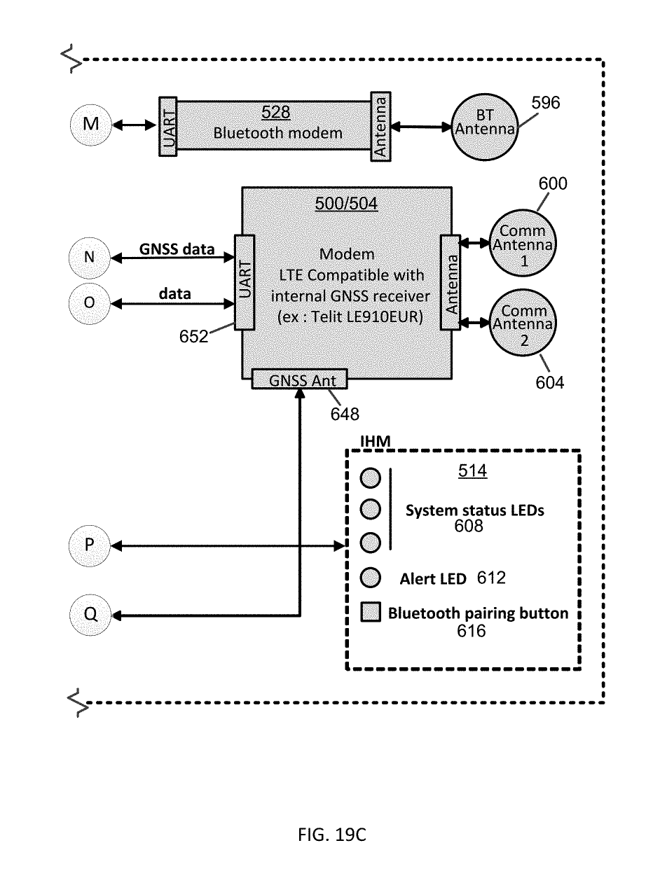

Referring to FIGS. 19A, 19B, and 19C, one embodiment of the hardware layout of the mobile unit circuit 54 is shown. The circuit comprises a power module 508, a processing module 512, a wireless communication module 504, and an alert module 514. The system may optionally comprise an external sensor module 532 and a security firewall 538 to monitor incoming data to the vehicle CAN network.

The power module 508 of the circuit comprises at least a power converter 536 and at least one super capacitor 540. In one embodiment, the power converter 536 converts the vehicle DC power source voltage input into a different required DC voltage to power the circuit electronics. In one embodiment, the circuit 508 comprises multiple super capacitors 540 in the power module 508. In a preferred embodiment, power module 508 comprises one or more of the super capacitors 540 to alleviate the need for batteries in aircraft. However, in other embodiments, a battery may be added between the power inlet and power modules for ground vehicles allowing, for example, the localization of parked vehicles. In one embodiment, the one or more super capacitors 540 are electrolyte capacitors. In other embodiments, the power module 508 comprises a battery charger 544 and a rechargeable battery 548.

The processing module of the circuit 54 comprises a computer processing unit (CPU) 512. In one embodiment, the CPU 512 includes at least three general-purpose input/output (GPIO) ports 552, at least two universal asynchronous receiver-transmitter (UART) ports 556, at least one NET port 560, and at least one Inter-Integrated Circuit

(I²C) port 564. In one embodiment, the CPU 512 is the 32-bit processor Cortex-M3 TQFP144 ARM processor from NXP Semiconductors, Billerica Mass., USA 01821 which includes 512 KB Flash RAM 516. In other embodiments, the CPU 512 is any suitable CPU.

The CPU 512 interfaces with at least one audio codec 524 through the I²C port 564. The at least one audio codec 524 transmits and receives audio signals through either a wired or wireless connection (wired connection shown). In one embodiment, the audio codec 524 is connected to at least one headset 566 for a mobile user. In one embodiment, the audio codec 524 is connected to at least one microphone 570 for a mobile user. In one embodiment, the audio codec 524 is connected to at least one headset 566′ for the vehicle. In one embodiment, the audio codec 524 is connected to at least one microphone 570′ for the vehicle.

The processing module further comprises a Global Navigation Satellite System (GNSS) 500 that interfaces with and sends data to the CPU 516 through the GPIO 552. In one embodiment, the GNSS receiver 500 comprises a GNSS receiver 500. In a preferred embodiment, the GNSS receiver 500 is compatible with satellite-based augmentation systems (SBAS) and differential global navigation satellite systems (DGNSS). In one embodiment, the GNSS receiver 500 is a NEO-7P module by u-blox (Thalwil, Switzerland). In one embodiment, the GNSS receiver 500 has a precision of less than one meter, and has at least fifty-six channels. In other embodiments, any suitable GNSS receiver may be used.

Referring also to FIGS. 19B and 19C, in one embodiment, the GNSS receiver 500 includes a switch 632 connected to the antenna port 636 of the GNSS receiver 500. The switch 632 includes a first input connected to an internal antenna 640, a second input connected to an external antenna 644, and a third input 648 connected to the GNSS receiver antenna port of a modem 500. In a preferred embodiment, the GNSS receiver 500 further comprises a GNSS processor 580, an SBAS DGNSS processor 584, one temperature sensor 588, and one pressure sensor 592. In some embodiments, the temperature sensor 588 and the pressure sensor 592 are in the same physical device.

The wireless communication modems 500, 528 of the circuit 54 comprise one or more wireless modems connected to the CPU 512 through UARTs 556, 556′. In one embodiment, one wireless modem connected to the CPU 512 by the UART 556 is a Bluetooth modem 528. The UART 556 accepts control information and data from the Bluetooth modem. The Bluetooth modem 528 connects to a Bluetooth antenna 596 to send and receive signals via a Bluetooth communications link. In other embodiments, any other suitable wireless modem and protocol may be used for this wireless link including, but not limited to, Zigbee, Wi-Fi, and cellular. The Bluetooth modem is used to communicate with mobile devices such as a smart phone which may act as an input/output display system.

A second wireless telecom modem 500 interfaces with the CPU 512 through a UART 556′. This telecom modem includes, in one embodiment, a separate GNSS receiver 504, a first communications antenna 600, a second communications antenna 604, a GNSS antenna 648 and its own UART 652. Communications between the two UARTS 556′ and 652 transfer GNSS and other data from the modem 500 and the CPU 516. In one embodiment, the telecom modem 500 is compatible with the Long-Term Evolution (LTE) standard or other telecommunications standard such as 4G. In one embodiment, the second modem 29 is a Telit LE910EU V2 (Telit Communications PLC London, England). In some embodiments, the second modem may be one of E910-NA V2, LE910-AU V2, or any other suitable modem.

Although the system uses the GNSS receiver 500 to determine location, the GNSS receiver 504 of the modem 500 can be connected to either the internal 640 or the external antenna 644 through switch 632. In this manner, the GNSS receiver 504 acts as a backup GNSS device supplying GNSS data to the CPU 512 through the UARTs 556′ and 652 if the main GNSS receiver 500 fails. The GNSS receiver 504 may also be used to check the quality of the data being supplied by the GNSS receiver 500. In one embodiment, the GNSS receiver 500 is a Neo 7 p high precision GNSS module by u-blox AG, Thalwil, Switzerland. In some embodiments, if the location data coming from the GNSS receiver 500 and the modem are divergent for more than 5 minutes at boot or more than 10 seconds when “hot,” the device will send a message (using the messaging subsystem shown in FIG. 12) that the device is faulty and will inform the user through an aural message that the system is not operating.

The alert module 514 of the illustrated circuit 54 includes one or more alert mechanisms. In one embodiment, the alert module 514 includes one or more light emitting diodes (LEDs) 608, 612 to alert the user of trajectories or collision warnings. In one embodiment, at least three LEDs 608 of different colors are used to alert the user of the system status. An additional LED 612 in a fourth color is designated as an Alert LED to warn of imminent collision or danger. The alert module 514 further includes a Bluetooth pairing button 616 to connect to any nearby Bluetooth device. In some embodiments, the alert module 514 may further comprise an audio alert to warn the user of imminent collision or danger.

In some embodiments, the circuit 54 (FIG. 19A) may comprise a sensor module 532. The sensor module 532 comprises an external sensor suite 622. The external sensor suite may include sensors for engine temperature, various pressures, alternator current, etc. The sensor suite may comprise a variety of multifunctional sensors in order to receive aspecific data from external sensors (622) or vehicle sensors (54). The sensor module 532 further comprises a signal transducer 628 that converts analog to digital data and transmits the digital data from the external sensor suite 622 to the CPU 512. In one embodiment, the signal transducer 628 is used to format the aspecific data from the sensor suite in a standardized way (for example a packet of bytes). One exemplary format to standardize the data for a packet is:

[Number of data packets][Size of packet 1][Type of packet 1][Data packet 1][Size of packet 2][Type of packet 2][Data packet 2]

This standardization allows a margin for expandability. These data may be stored in an object entitled “List of External Data Objects” for further use or analysis.

Unless specifically stated otherwise as apparent from the following discussion, it is appreciated that throughout the description, discussions utilizing terms such as “processing” or “computing” or “calculating” or “delaying” or “comparing”, “generating” or “determining” or “forwarding or “deferring” “committing” or “interrupting” or “handling” or “receiving” or “buffering” or “allocating” or “displaying” or “flagging” or Boolean logic or other set related operations or the like, refer to the action and processes of a computer system, or electronic device, that manipulates and transforms data represented as physical (electronic) quantities within the computer system's or electronic devices' registers and memories into other data similarly represented as physical quantities within electronic memories or registers or other such information storage, transmission or display devices.

The algorithms presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language, and various embodiments may thus be implemented using a variety of programming languages.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

The examples presented herein are intended to illustrate potential and specific implementations of the present disclosure. The examples are intended primarily for purposes of illustration of the invention for those skilled in the art. No particular aspect or aspects of the examples are necessarily intended to limit the scope of the present invention.

The figures and descriptions of the present invention have been simplified to illustrate elements that are relevant for a clear understanding of the present invention, while eliminating, for purposes of clarity, other elements. Those of ordinary skill in the art may recognize, however, that these sorts of focused discussions would not facilitate a better understanding of the present disclosure, and therefore, a more detailed description of such elements is not provided herein.

The processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A computer-readable medium may also include memory storage that may be physical, virtual, permanent, temporary, semi-permanent and/or semi-temporary.

Computer systems and computer-based devices disclosed herein may include memory for storing certain software applications used in obtaining, processing, and communicating information. It can be appreciated that such memory may be internal or external with respect to operation of the disclosed embodiments. The memory may also include any means for storing software, including a hard disk, an optical disk, floppy disk, ROM (read only memory), RAM (random access memory), PROM (programmable ROM), EEPROM (electrically erasable PROM) and/or other computer-readable memory media. In various embodiments, a “host,” “engine,” “loader,” “filter,” “platform,” or “component” may include various computers or computer systems, or may include a reasonable combination of software, firmware, and/or hardware.

In various embodiments of the present disclosure, a single component may be replaced by multiple components, and multiple components may be replaced by a single component, to perform a given function or functions. Except where such substitution would not be operative to practice embodiments of the present disclosure, such substitution is within the scope of the present disclosure. Any of the servers, for example, may be replaced by a “server farm” or other grouping of networked servers (e.g., a group of server blades) that are located and configured for cooperative functions. It can be appreciated that a server farm may serve to distribute workload between/among individual components of the farm and may expedite computing processes by harnessing the collective and cooperative power of multiple servers. Such server farms may employ load-balancing software that accomplishes tasks such as, for example, tracking demand for processing power from different machines, prioritizing and scheduling tasks based on network demand, and/or providing backup contingency in the event of component failure or reduction in operability.

In general, it may be apparent to one of ordinary skill in the art that various embodiments described herein, or components or parts thereof, may be implemented in many different embodiments of software, firmware, and/or hardware, or modules thereof. The software code or specialized control hardware used to implement some of the present embodiments is not limiting of the present disclosure. Programming languages for computer software and other computer-implemented instructions may be translated into machine language by a compiler or an assembler before execution and/or may be translated directly at run time by an interpreter.

Examples of assembly languages include ARM, MIPS, and x86; examples of high level languages include Ada, BASIC, C, C++, C#, COBOL, Fortran, Java, Lisp, Pascal, Object Pascal; and examples of scripting languages include Bourne script, JavaScript, Python, Ruby, PHP, and Perl. Various embodiments may be employed in a Lotus Notes environment, for example. Such software may be stored on any type of suitable computer-readable medium or media such as, for example, a magnetic or optical storage medium. Thus, the operation and behavior of the embodiments are described without specific reference to the actual software code or specialized hardware components. The absence of such specific references is feasible because it is clearly understood that artisans of ordinary skill would be able to design software and control hardware to implement the embodiments of the present disclosure based on the description herein with only a reasonable effort and without undue experimentation.

Various embodiments of the systems and methods described herein may employ one or more electronic computer networks to promote communication among different components, transfer data, or to share resources and information. Such computer networks can be classified according to the hardware and software technology that is used to interconnect the devices in the network.

The computer network may be characterized based on functional relationships among the elements or components of the network, such as active networking, client-server, or peer-to-peer functional architecture. The computer network may be classified according to network topology, such as bus network, star network, ring network, mesh network, star-bus network, or hierarchical topology network, for example. The computer network may also be classified based on the method employed for data communication, such as digital and analog networks.

Embodiments of the methods, systems, and tools described herein may employ internetworking for connecting two or more distinct electronic computer networks or network segments through a common routing technology. The type of internetwork employed may depend on administration and/or participation in the internetwork. Non-limiting examples of internetworks include intranet, extranet, and Internet. Intranets and extranets may or may not have connections to the Internet. If connected to the Internet, the intranet or extranet may be protected with appropriate authentication technology or other security measures. As applied herein, an intranet can be a group of networks which employ Internet Protocol, web browsers and/or file transfer applications, under common control by an administrative entity. Such an administrative entity could restrict access to the intranet to only authorized users, for example, or another internal network of an organization or commercial entity.

Unless otherwise indicated, all numbers expressing lengths, widths, depths, or other dimensions and so forth used in the specification and claims are to be understood in all instances as indicating both the exact values as shown and as being modified by the term “about.” As used herein, the term “about” refers to a ±10% variation from the nominal value. Accordingly, unless indicated to the contrary, the numerical parameters set forth in the specification and attached claims are approximations that may vary depending upon the desired properties sought to be obtained. At the very least, and not as an attempt to limit the application of the doctrine of equivalents to the scope of the claims, each numerical parameter should at least be construed in light of the number of reported significant digits and by applying ordinary rounding techniques. Any specific value may vary by 20%.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes which come within the meaning and range of equivalency of the claims are intended to be embraced therein.

It will be appreciated by those skilled in the art that various modifications and changes may be made without departing from the scope of the described technology. Such modifications and changes are intended to fall within the scope of the embodiments that are described. It will also be appreciated by those of skill in the art that features included in one embodiment are interchangeable with other embodiments; and that one or more features from a depicted embodiment can be included with other depicted embodiments in any combination. For example, any of the various components described herein and/or depicted in the figures may be combined, interchanged, or excluded from other embodiments.

What is claimed is:

1. A virtual radar system comprising:
a vehicle-based subsystem, said vehicle-based subsystem located in a vehicle, said vehicle-based subsystem comprising:
a GNSS receiver to generate a position location for said vehicle;
a vehicle subsystem processor in communication with said GNSS receiver;
a vehicle-based human interface subsystem comprising a display and a data input unit; and
a vehicle-based network modem in communication with the vehicle subsystem processor; and
a cloud-based data subsystem comprising:
a cloud-based database for holding data comprising a plurality of locations of a plurality of vehicles;
a plurality of cloud transaction processors in communication with the cloud-based database; and
a cloud-based network modem in communication with the plurality of transaction processors,
wherein said cloud transaction processors calculate the positions of the plurality of vehicles, their trajectories, and the probability of there being a collision between vehicles and issues a warning to the vehicles in response thereto.

2. The virtual radar system of claim 1 further comprising:
a control station subsystem, comprising:
a control station subsystem processor;
a control station subsystem-based human interface subsystem comprising a control system-based display and a control system-based data input unit, said control station subsystem-based human interface subsystem in communication with said control station subsystem processor;
a control station subsystem network modem in communication with the control station subsystem processor;

3. The virtual radar system of claim 1 wherein both the vehicle-based subsystem and the control station subsystem further each comprise a cryptographic engine in communication between their respective network modem and their respective processor.

4. The virtual radar system of claim 1 wherein the cloud transaction processors comprise:
a position processing engine;
an AI engine;
a black box storage database;
a transient database in communication with the position processing engine and the AI engine; and
an AI database in communication with the position processing engine and the AI engine.

5. The virtual radar system of claim 3 wherein the AI engine comprises:
a path prediction engine;
a collision prediction engine; and
a machine learning engine.

6. The virtual radar system of claim 5 wherein the collision prediction engine issues a collision alert in response to predicted path data from the path prediction engine.

7. A virtual radar system vehicle-based subsystem comprising:
a CPU;
a modem comprising a first GNSS receiver in communication with the CPU;
and
an audio codec in communication with the CPU,
wherein the first GNSS receiver provides position data to the CPU, and
wherein the CPU transmits the GNSS position data to a cloud transaction server for collision prediction.

8. The virtual radar system vehicle-based subsystem of claim 7 further comprising a second GNSS receiver in communication with the CPU, the second GNSS receiver providing position data to the CPU.

9. The virtual radar vehicle-based subsystem of claim 8 wherein the CPU generates an error warning if the position data indicated by the first and second GNSS receivers differ by more than a predetermined amount.

10. The virtual radar system vehicle-based subsystem of claim 7 further comprising a Bluetooth modem in communication with the CPU.

11. The virtual radar system vehicle-based subsystem of claim 7 further comprising a plurality of vehicle system sensors and external sensors in communication with the CPU.

12. A method of operating a virtual radar system comprising a server, a plurality of vehicle-based subsystems and a cloud-based data subsystem comprising a plurality of databases, the method comprising the steps of:
registering each of the vehicle-based subsystems with the cloud-based data subsystem;
creating a record for each of the plurality of the vehicle-based subsystems in one of the plurality of databases in the cloud-based data subsystem;
receiving, by the server, a respective position message from each of the plurality of vehicle-based subsystems and storing it in a position database in the cloud-based data subsystem;
receiving, by the server, a subsequent position message from each of the plurality of the vehicle-based subsystems and storing it the position database in the cloud-based data subsystem;
calculating, by the server, a trajectory for each of the plurality of the vehicle-based subsystems;
calculating, by the server, the distance between each of the plurality of vehicle-based subsystems based on their respective trajectories; and
issuing by the server, a collision warning to each of the vehicle-based subsystems whose trajectories will pass within a predetermined volume of space of each other at a specific point in time.

13. The method of operating the virtual radar system of claim 12 wherein the virtual radar system further comprises a control station subsystem and wherein the server also issues the collision warning to the control station subsystem.

14. The method of operating the virtual radar system of claim 12 wherein the predetermined volume of space is determined by an AI engine in response to the positions of each of the vehicle-based subsystems.

15. The method of operating the virtual radar system of claim 12 further comprising the step of deregistering a vehicle-based subsystem that is no longer active.

16. The method of operating the virtual radar system of claim 15 further comprising the step of closing the record of the inactive vehicle-based subsystem.

17. The method of operating the virtual radar system of claim 15 further comprising the step of maintaining the record of the inactive vehicle-based subsystem in a black box database.
